(19) United States
(12) Patent Application Publication
(10) Pub. No.: US 2026/0182638 A1
(43) Pub. Date: Jul. 2, 2026

(54) HEATER ASSEMBLY AND METHOD

(71) Applicant: Nicoventures Trading Limited, London (GB)

(72) Inventors: Howard ROTHWELL, London (GB); Ugurhan YILMAZ, London (GB)

(21) Appl. No.: 19/130,358

(22) PCT Filed: Nov. 10, 2023
(86) PCT No.: PCT/GB2023/052944

§ 371 Date: May 15, 2025

(30) Foreign Application Priority Data
Nov. 15, 2022 (GB) 2217022.9

(51) Int. Cl. A24F 40/46; A24F 40/10; A24F 40/42; A24F 40/44; A24F 40/485

(52) U.S. Cl. CPC A24F 40/46; A24F 40/44; A24F 40/485; A24F 40/10; A24F 40/42

(57) ABSTRACT

Described is a heater assembly for an aerosol provision system, the heater assembly having a plurality of outer surfaces including a first outer surface. The heater assembly further includes: a substrate; a heater layer configured to generate heat when supplied with energy, the heater layer provided at the first outer surface of the heater assembly; one or more capillary tubes extending from another outer surface of the heater assembly through the heater layer provided at the first outer surface of the heater assembly; and one or more distribution channels provided on a surface of the substrate and for guiding aerosol-generating material along a path extending along the surface of the substrate. Also described is an aerosol provision system including the heater assembly and a method for manufacturing a heater assembly.

### CROSS-REFERENCE TO RELATED APPLICATIONS

This present application is a National Phase entry of PCT Application No. PCT/GB2023/052944, filed Nov. 10, 2023, which claims priority from Great Britian Application No. 2217022.9, filed Nov. 15, 2022, each of which are fully incorporated herein by reference in their entireties.

### FIELD

The present disclosure relates to electronic aerosol provision systems such as nicotine delivery systems (e.g. electronic cigarettes and the like).

### BACKGROUND

Electronic aerosol provision systems such as electronic cigarettes (e-cigarettes) generally contain a reservoir of a source liquid containing a formulation, typically including nicotine, from which an aerosol is generated, e.g. through heat vaporisation. An aerosol source for an aerosol provision system may thus comprise a heater having a heating element arranged to receive source liquid from the reservoir, for example through wicking/capillary action. While a user inhales on the device, electrical power is supplied to the heating element to vaporise source liquid in the vicinity of the heating element to generate an aerosol for inhalation by the user. Such devices are usually provided with one or more air inlet holes located away from a mouthpiece end of the system. When a user sucks on a mouthpiece connected to the mouthpiece end of the system, air is drawn in through the inlet holes and past the aerosol source. There is a flow path connecting between the aerosol source and an opening in the mouthpiece so that air drawn past the aerosol source continues along the flow path to the mouthpiece opening, carrying some of the aerosol from the aerosol source with it. The aerosol-carrying air exits the aerosol provision system through the mouthpiece opening for inhalation by the user.

Typically, such electronic aerosol provision systems are provided with heater assemblies suitable for heating the source liquid to form an aerosol. However, an example of such a heater assembly is a wick and coil heater assembly, which is formed of a coil of wire (typically nichrome NiCr 8020) wrapped or coiled around a wick (which typically comprises a bundle of collected fibres, such as cotton fibres, extending along the longitudinal axis of the coil of wire). Ends of the wick extend either side of the coil of wire and are inserted into the reservoir of source liquid.

However, such heater assemblies are not necessarily suited for all applications or all configurations of electronic aerosol provision systems. Such problems associated with these heater assemblies typically concern burning or charring of the wick material caused by the heater operating at too high a temperature, particularly when insufficient liquid is supplied to the heater assembly. In addition, the performance characteristics of these heater assemblies are generally not considered optimal and alternative solutions which are capable of providing more optimal aerosol delivery are desired.

Various approaches are described which seek to help address some of these issues.

### SUMMARY

According to a first aspect of certain embodiments there is provided a heater assembly for an aerosol provision system, the heater assembly having a plurality of outer surfaces including a first outer surface. The heater assembly comprises: a substrate; a heater layer configured to generate heat when supplied with energy, the heater layer provided at the first outer surface of the heater assembly; one or more capillary tubes extending from another outer surface of the heater assembly through the heater layer provided at the first outer surface of the heater assembly; and one or more distribution channels provided on a surface of the substrate and for guiding aerosol-generating material along a path extending along the surface of the substrate.

According to a second aspect of certain embodiments there is provided an aerosol provision system comprising the heater assembly of the first aspect, wherein the aerosol provision system comprises an aerosol-generating material storage portion for storing aerosol-generating material.

According to a third aspect of certain embodiments there is provided a method for manufacturing a heater assembly for an aerosol provision system, the heater assembly having a plurality of outer surfaces including a first outer surface, the method including: providing a substrate; providing a heater layer at the first outer surface of the heater assembly, the heater layer configured to generate heat when supplied with energy; providing one or more capillary tubes extending from another outer surface of the heater assembly through the heater layer provided at the first outer surface of the heater assembly; and providing one or more distribution channels provided on a surface of the substrate and for guiding aerosol-generating material along a path extending along the surface of the substrate.

According to a fourth aspect of certain embodiments there is provided a heater means for an aerosol provision system, the heater means having a plurality of outer surfaces including a first outer surface, the heater means including: a substrate; heater layer means configured to generate heat when supplied with energy, the heater layer means provided at the first outer surface of the heater means; capillary means extending from another outer surface of the heater means through the heater layer means provided at the first outer surface of the heater means; and distribution means provided on a surface of the substrate and for guiding aerosol-generating material along a path along the surface of the substrate.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

Embodiments of the invention will now be described, by way of example only, with reference to the accompanying drawings, in which:

FIG. 1 is a perspective view of an aerosol provision system in accordance with aspects of the present disclosure;

FIG. 2 is an exploded perspective view of a cartomiser suitable for use in the aerosol provision system of FIG. 1;

FIGS. 3a and 3b schematically show parts of the cartomiser of FIGS. 1 and 2 in more detail, where FIG. 3a shows a cross-sectional view of one side of a lower part of the cartomiser, and FIG. 3b shows a cross-sectional view of the lower surface of the upper sealing unit and heater assembly, in particular showing the elongate recess of the upper sealing unit;

FIG. 4 is a perspective view of a heater assembly in accordance with aspects of the present disclosure, wherein the heater assembly comprises a substrate, an electrically resistive layer, capillary tubes extending through the substrate and electrically resistive layer, and one or more distribution channels;

FIGS. 5a to 5c are views of different implementations of the heater assembly of FIG. 4, in particular showing different arrangements of the distribution channels provided on a surface of the substrate that, in use, is exposed to the reservoir of the cartomiser, where FIG. 5a shows linear distribution channels extending along a first direction according to a first example, FIG. 5b shows linear distribution channels extending along a first and second direction according to a second example, and FIG. 5c shows a zig-zag distribution channel according to a third example;

FIGS. 6a to 6c are views of different implementations of the heater assembly of FIG. 4, in particular showing different arrangements of the distribution channels provided on a surface of the substrate that, in use, receives the electrically resistive layer, where FIG. 6a shows linear distribution channels extending along a first direction according to a first example,

FIG. 6b shows linear distribution channels extending along a first and second direction according to a second example, and FIG. 6c shows a zig-zag distribution channel according to a third example;

FIG. 7 schematically shows a heater assembly comprising a plurality of substrates formed in a stacked arrangement, wherein distribution channels are provided on the surfaces of the substrates that abut one another in the stacked configuration; and

FIG. 8 is a method in accordance with aspects of the present disclosure for forming a heater assembly.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the non-combustible aerosol provision system is an electronic cigarette, also known as a vaping device, electronic cigarette or electronic nicotine delivery system (END), although it is noted that the presence of nicotine in the aerosol-generating material is not a requirement. Throughout the following description the term “e-cigarette” is sometimes used but this term may be used interchangeably with aerosol (vapour) provision system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

In some embodiments, the or each aerosol-generating material may comprise one or more active constituents, one or more flavours, one or more aerosol-former materials, and/or one or more other functional materials.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibres, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or is derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

As used herein, the terms “flavour” and “flavourant” refer to materials which, where local regulations permit, may be used to create a desired taste, aroma or other somatosensorial sensation in a product for adult consumers. They may include naturally occurring flavour materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavour enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form.

In some embodiments, the flavour comprises menthol, spearmint and/or peppermint. In some embodiments, the flavour comprises flavour components of cucumber, blueberry, citrus fruits and/or redberry. In some embodiments, the flavour comprises eugenol. In some embodiments, the flavour comprises flavour components extracted from tobacco. In some embodiments, the flavour comprises flavour components extracted from cannabis.

In some embodiments, the flavour may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants. An aerosol-modifying agent is a substance, typically located downstream of the aerosol generation area, that is configured to modify the aerosol generated, for example by changing the taste, flavour, acidity or another characteristic of the aerosol. The aerosol-modifying agent may be provided in an aerosol-modifying agent release component, that is operable to selectively release the aerosol-modifying agent.

The aerosol-modifying agent may, for example, be an additive or a sorbent. The aerosol-modifying agent may, for example, comprise one or more of a flavourant, a colourant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

Typically, the non-combustible aerosol provision system may comprise a non-combustible aerosol provision device and a consumable for use with the non-combustible aerosol provision device. In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a mouthpiece, and/or an aerosol-modifying agent.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

In accordance with the principles of the present disclosure, a heater assembly is provided which includes one or more capillary tubes extending through the heater assembly from one side to another side of the heater assembly. The function of the capillary tubes is to supply liquid aerosol-generating material (or any other aerosol-generating material capable of flowing) from the first side of the heater assembly to a second side of the heater assembly where a heater layer (i.e. a layer that is configured to increase its temperature in response to application of electrical power) is capable of vaporising the liquid aerosol-generating material. One or more distribution channels are provided in the surface of a substrate forming (or partly forming) the heater assembly. Distribution channels that are provided such that in use they face or have an opening exposed to the liquid aerosol-generating material storage portion are broadly configured to help supply or channel liquid to the capillary tubes such that the capillary tubes can be better supplied with liquid and subsequently are capable of supplying the liquid to the heater layer. Distribution channels that are provided such that they are present on the heater layer are configured to either channel liquid aerosol-generating material (for example, away from the capillary tube openings) to better distribute the liquid aerosol-generating material over the heater layer, or to collect condensed liquid (i.e., liquid that is formed from vaporised liquid aerosol-generating material condensing) at the surface of the heater assembly. Therefore, it can be seen that providing the heater assembly with one or more distribution channels on one or more surface of a substrate of the heater assembly may help improve the performance of the heater assembly, both in terms of the ability to transport liquid aerosol-generating material to the heater layer and in the ability to generate aerosol by distributing the liquid aerosol-generating material across the surface of the heater layer.

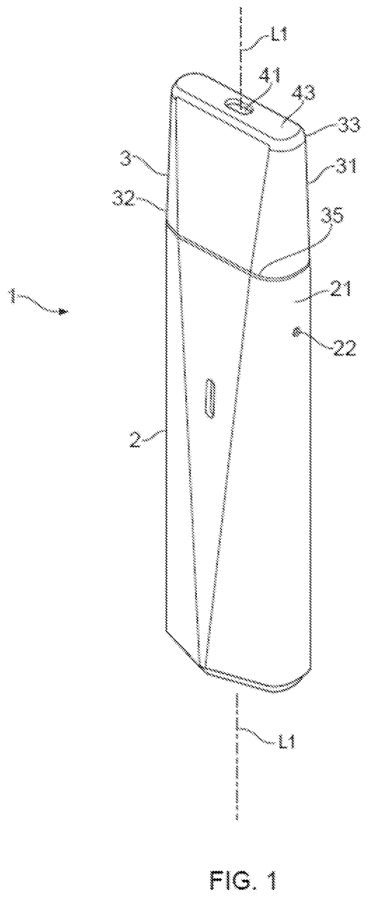

FIG. 1 schematically shows an aerosol provision system 1 in accordance with aspects of the present disclosure. The aerosol provision system 1 comprises an aerosol provision device 2 and a consumable 3, herein shown and referred to as a cartomiser 3. The aerosol provision device 2 and the cartomiser 3 together form the aerosol provision system 1.

The cartomiser 3 is configured to engage and disengage with the aerosol provision device 2. That is, the cartomiser 3 is releasably connected/connectable to the aerosol provision device 2. More specifically, the cartomiser 3 is configured to engage/disengage with the aerosol provision device 2 along the longitudinal axis L1. The cartomiser 3 and aerosol provision device 2 are provided with suitable interfaces to allow the cartomiser 3 and aerosol provision device 2 to engage/disengage from one another, e.g., a push fit interface, a screwthread interface, etc.

The cartomiser 3 comprises a reservoir which stores an aerosol-generating material. Accordingly, the reservoir may also be referred to as an aerosol-generating material storage portion. In the following, the aerosol-generating material is a liquid aerosol-generating material. The liquid aerosol-generating material (herein sometimes referred to simply as liquid, source liquid or e-liquid) may be a conventional e-liquid which may or may not contain nicotine. However, it should be appreciated that other liquids and/or aerosol-generating materials may be used in accordance with the principles of the present disclosure. The cartomiser 3 is able to be removed from the aerosol provision device 2 when, for example, the cartomiser 3 requires refilling with liquid or replacement with another (full) cartomiser 3.

The aerosol provision device 2 comprises a power source (such as a rechargeable battery) and control electronics. As will be described below, the cartomiser 3 comprises an electrically powered heater assembly. When the cartomiser 3 is coupled to the aerosol provision device 2, the control electronics of the aerosol provision device 2 are configured to supply electrical power to the heater assembly of the cartomiser 3 to cause the heater assembly to generate an aerosol from the liquid aerosol-generating material supplied thereto. The control electronics may be provided with various components to facilitate control the supply of power to the cartomiser 3. For example, the control electronics may be provided with an airflow sensor (not shown) configured to detect when a user of the aerosol provision system 1 inhales on the aerosol provision system and to supply power in response to such a detection and/or a push button (not shown) which is pressed by the user and to supply power in response to such a detection. Additional functions may be controlled by the control electronics depending on the configuration of the aerosol provision device 2 (for example, the control electronics may be configured to control/regulate recharging of the power source, or to facilitate wireless communication with another electronic device, such as a smartphone). The features and functions of the aerosol provision device 2 are not of primary significance in respect of the present disclosure.

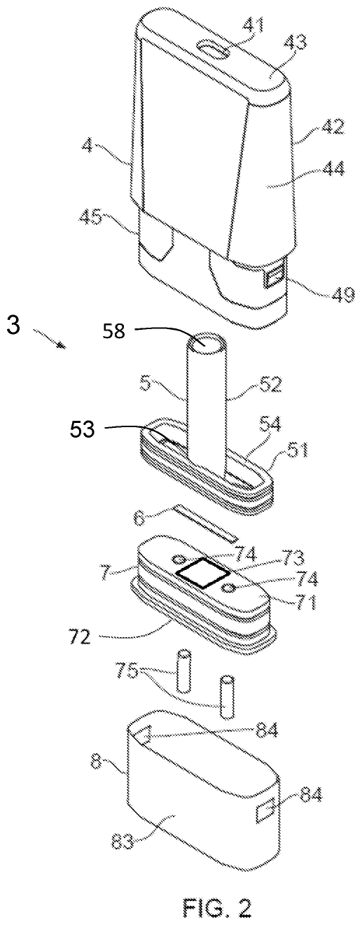

FIG. 2 shows an example cartomiser 3 suitable for use in the aerosol provision system of FIG. 1. From the exploded view of FIG. 2, it may be seen that the cartomiser 3 is assembled from a stack of components: an outer housing 4, an upper sealing unit 5, a heater assembly 6, a lower support unit 7 and an end cap 8.

The cartomiser 3 has a top end 31 and a bottom end 32 which are spaced apart along the longitudinal axis L1, which is the longitudinal axis of the cartomiser as well as being the longitudinal axis of the aerosol provision system 1. The top end 31 of the cartomiser 3 defines a mouthpiece 33 of the aerosol provision system 1 (around which a user may place their mouth and inhale). The mouthpiece 33 includes a mouthpiece orifice 41 which is provided at the top end 42 of outer housing 4 in the centre of a top face 43.

The outer housing 4 includes a circumferential side wall 44 which leads down from the top end 42 to a bottom end 45 of the outer housing 4 and which defines an internal reservoir 46 for holding the liquid aerosol-generating material. Prior to assembly of the cartomiser 3, the bottom end 45 of the outer housing is open, but upon assembly the bottom end 45 is closed by a plug formed by the upper sealing unit 5 and the lower support unit 7 which are stacked together with the heater assembly 6 positioned therebetween.

The upper sealing unit 5 is an intermediate component of the stack of components. The upper sealing unit 5 includes a foot 51 in the form of a block and an upwardly extending air tube 52. On each side of the air tube 52, the foot 51 includes a well 53 which descends from a flat top surface 54 to a flat bottom surface (not shown in FIG. 2) of the foot 51. At the bottom surface, each well 53 is open and, specifically, opens into an elongate recess formed in the bottom surface, with the depth of the recess broadly matching the thickness of the heater assembly 6. The recess is provided to accommodate the heater assembly 6 when the upper sealing unit 5 is engaged with the lower support unit 7, however the recess portion is also sized so as to provide a gap around at least a part of the periphery of the heater assembly 6 when the heater assembly 6 is located in the recess portion. The foot 51 is designed to engage with the outer housing 4 (more specifically, such that the outer circumferential surface of the foot is pressed against an inner circumferential surface of the outer housing 4). The foot 51 may have a suitable shape and include suitable sealing components to reduce or prevent liquid from leaking between the outer surface of the foot 51 and the inner surface of the housing 4.

The air tube 52 extends up from the bottom of the wells 53 and defines an internal air passage 58. When the upper sealing unit 5 is engaged with the outer housing 4, the air tube 52 extends up to and encircles the mouthpiece orifice 41. The outer housing 4 and/or the air tube 52 may be suitably configured so as to provide a liquid-(and optionally air-) tight seal between the two. As will be understood below, air/aerosol is intended to pass along the air tube 52 and out of the mouthpiece orifice 41, while the space around the air tube 52 and within the outer housing 4 defines the reservoir 46 for storing the liquid aerosol-generating material. Hence, it should be understood that, with the exception of the openings of the wells 53, the reservoir 46 is a sealed volume defined by the outer housing 4, the outer surface of the air tube 52, and the foot 51.

The lower support unit 7 is in the form of a block having a broadly flat top surface 71 and a flat bottom surface 72. A central air passage 73 extends upwardly from the bottom surface 72 to the top surface 71. On each side of the air passage 73, the block of the lower support unit 7 includes a through hole 74. In the example cartomiser 3 of FIG. 2, a co-moulded contact pad 75 in the form of a pin is inserted into the through holes 74. More specifically, each contact pad 75 is press fit in its respective through hole 74. Each contact pad 75 provides an electrical connection path from the bottom surface 72 to a respective end portion of the heater assembly 6 when the heater assembly 6 is sandwiched between the top surface 71 of the lower support unit 7 and the recess of the bottom surface 55 of the upper sealing unit 5.

Much like the upper sealing unit 5, the lower support unit 7 is designed to engage with the outer housing 4 (more specifically, such that the outer circumferential surface of the lower support unit 7 is pressed against an inner circumferential surface of the outer housing 4). The lower support unit 7 may have a suitable shape and include suitable sealing components to reduce or prevent liquid from leaking between the outer surface of the lower support unit 7 and the inner surface of the housing 4. The foot 51 of the upper sealing unit 5 and the lower support unit 7 (with its block-like form) combine together to form a plug which seals the bottom end of the reservoir 46.

As shown in FIG. 2, the cartomiser 3 includes an end cap 8 at its bottom end. The end cap 8 is made of metal and serves to assist with retaining the cartomiser 3 in the aerosol provision device 2 when the cartomiser 3 is plugged in to the top end of the aerosol provision device 2, because, in this example, the aerosol provision device 2 is provided with magnets which are attracted to the metal of the end cap 8. The end cap 8 has a bottom wall 81 with a central opening (not shown in FIG. 2). The end cap 8 also has a circumferential side wall 83 which has two opposed cut-outs 84 which latch onto corresponding projections 49 on the outer surface of the bottom end of the side wall 44 of the outer housing 4, so that the end cap 8 has a snap-fit type connection onto the bottom end of the outer housing 4. When the end cap 8 has been fitted in position, it holds in position the lower support unit 7, the upper sealing unit 5 and the heater assembly 6 which is sandwiched between the lower support unit 7 and the upper sealing unit 5.

It would be possible to omit the end cap 8 (in order to reduce the component count) by arranging for the lower support unit 7 to form a snap-fit type connection with the bottom end of the side wall 44 of the outer housing 4. Additionally, the cartomiser 3 could be provided with indentations which engage with projections at the top end 21 of the main housing 2, so that a releasable connection is provided between the cartomiser and the main housing.

In any case, the cartomiser 3 is provided what may more generally be referred to as a device interface which is a part of the cartomiser 3 that interfaces with the main housing 2 (or aerosol-generating device 2). In the above example, the device interface may include the metal cap 8 including the bottom wall 81 and circumferential side wall 83 and/or the lower support unit 7 including the bottom surface 72. More generally, the device interface of the cartomiser 3 may encompass any part or parts of the cartomiser 3 that contact, abut, engage or otherwise couple to the main housing 2.

When the components of the cartomiser 3 have been assembled together, an overall air passage exists from the bottom end 32 to the top end 31 of the cartomiser 3 and it is formed by the air passage 73 leading to the air passage 58 which, in turn, leads to the mouthpiece orifice 41. Where the air passage 73 meets the air passage 58, the air flow bifurcates as it passes around the side edges of the heater assembly 6.

With reference back to FIG. 1, the top end 21 of the aerosol provision device 2 includes an air inlet hole 22 on each side of the aerosol provision device 2 (with one of the two air inlet holes 22 being visible in FIG. 1). Air can enter the air inlet holes 22 and flow transversely inwards to the longitudinal axis L1 so as to enter the bottom end of the air passage 73 of the lower support unit 7 and to start to flow in the direction of the longitudinal axis L1 towards the mouthpiece 33.

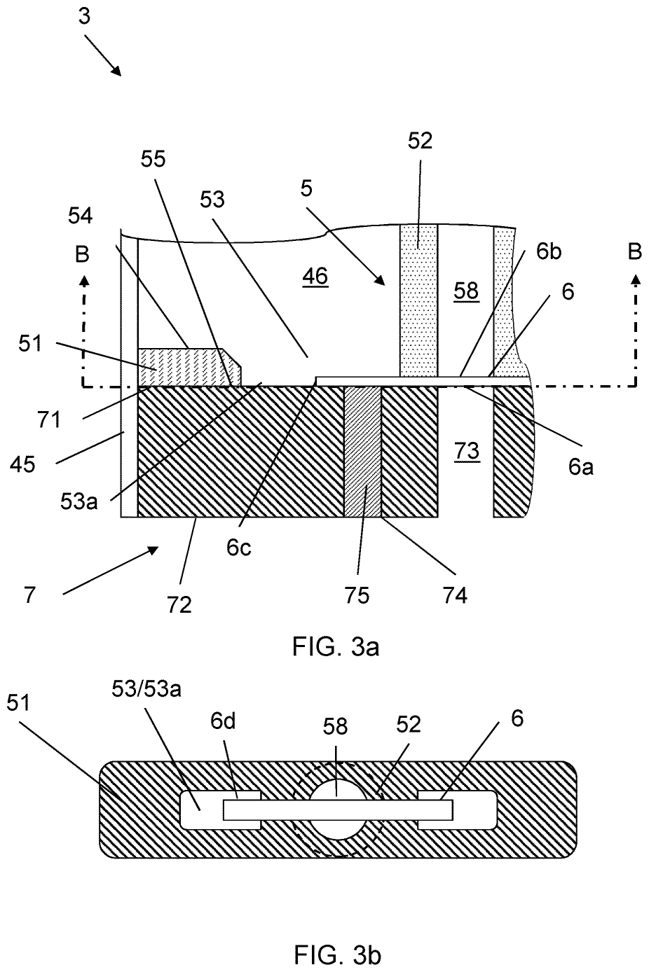

FIG. 3a schematically shows a part of the cartomiser 3 of FIGS. 1 and 2 in cross-section. Specifically, FIG. 3a shows a part of the cartomiser 3 corresponding to the lower left-hand side of the cartomiser 3, where “lower” as used here refers to a part of the cartomiser 3 closer to the cap 8 than the mouthpiece 33. The cross-section shown is that of a plane extending along the longitudinal axis L1 of the cartomiser 3 and perpendicular to the longitudinal extent of the heater assembly 6.

FIG. 3b schematically shows a view along the longitudinal axis L1 of the cartomiser 3 towards the bottom surface 55 of the upper sealing unit 5 with the heater assembly 6 in position (note, this view is along the direction shown in FIG. 3a and labelled “B”). Certain features of cartomiser 3 of FIGS. 1 and 2 have been omitted for clarity.

FIGS. 3a and 3b show the relative arrangement of the heater assembly 6, the upper sealing unit 5 and lower support unit 7, and in particular, the position of the well 53 formed in the foot 51 of the upper sealing unit 5 relative to the ends of the heater assembly 6. The heater assembly 6 is located in the elongate recess provided in the foot 51 of the upper sealing unit 5.

The heater assembly 6 is provided such that, when the cartomiser 3 is assembled, a first surface 6a of the heater assembly 6 abuts the top surface 71 of the lower support unit 7. The foot 51 of the upper sealing unit 5 includes the elongate recess which is suitable for accommodating the heater assembly 6. At a central portion of the heater assembly 6, the elongate recess is sized such that it has a depth approximately equal to the depth or thickness of the heater assembly 6, and a width approximately equal to the width of the heater assembly 6. In FIG. 3b, this can be seen as those portions of the upper sealing unit 5 that abut or touch the longer sides of the heater assembly 6. With reference to FIG. 3a, the heater assembly 6 is sandwiched between the lower surface of the air tube 52 of the upper sealing unit 5 and the top surface 71 of the lower support unit 7. The lower surface of the air tube 52 contacts a second surface 6b of the heater assembly 6, where the second surface 6b of the heater assembly 6 is opposite the first surface 6a of the heater assembly 6. The lower surface of the air tube 52 together with the sides of the recess portion of the foot 51 create a seal between the reservoir 46 and the air channel 58/air channel 73. It should be understood therefore that there is a portion of the heater assembly 6 (i.e., either end of the heater assembly 6) that is in direct fluid communication with the reservoir 46 and a portion of the heater assembly 6 (i.e., a central portion of the heater assembly 6) that is in indirect fluid communication with the reservoir 46 via the ends of the heater assembly 6. Heating of the liquid to achieve vaporisation or aerosol generation is performed at least in the central portion of the heater assembly 6 such that vaporised liquid is able to be entrained in air passing around the central portion of the heater assembly 6 from air passage 73 that subsequently passes to air passage 58.

At least a part of the elongate recess is sized so as to be greater in at least one dimension than the heater assembly 6. In the described implementation, the elongate recess of FIGS. 3a and 3b (seen best in FIG. 3b) is longer than the heater assembly 6, and in addition the ends of the elongate recess are sized to be wider than the heater assembly 6. The wells 53 formed in the foot 51 of the upper sealing unit 5 include an opening 53a which at least partially overlaps with the heater assembly 6 (seen best in FIG. 3b). The wells 53 and openings 53a allow liquid aerosol-generating material to contact the parts of the heater assembly 6 that overlap with the openings 53a of the wells 53. In particular, at least a portion of the second surface 6b of the heater assembly 6 is able to contact the liquid aerosol-generating material in the reservoir 46. By virtue of the fact that the elongate recess is sized to be longer than the heater assembly 6, and that the elongate recess also partially overlaps with the openings 53a, a third surface 6c of the heater assembly 6 is also able to contact the liquid aerosol-generating material in the reservoir 46. The third surface 6c is the surface of the heater assembly 6 at either end of the heater assembly 6 (seen best in FIG. 3a). The third surface 6c is defined by the width and thickness of the heater assembly 6. By virtue of the fact that the ends of the elongate recess are sized to be wider than the heater assembly 6, and that the elongate recess also partially overlaps with the openings 53a, at least a part of a fourth surface 6d of the heater assembly 6 is also able to contact the liquid aerosol-generating material in the reservoir 46. The fourth surface 6c is the surface of the heater assembly 6 along either side of the heater assembly 6 (seen best in FIG. 3b). The fourth surface 6d is defined by the length and thickness of the heater assembly 6.

Accordingly, the heater assembly 6 is arranged in the cartomiser 3 such that multiple surfaces (or parts thereof) of the heater assembly 6 are provided in direct contact with the reservoir 46. It should be appreciated that the multiple surfaces (or parts thereof) of the heater assembly 6 are provided in contact with the liquid aerosol-generating material in the reservoir 46 only in the event that the liquid aerosol-generating material is present in the wells 53. For example, if the cartomiser 3 is inverted during use (i.e., rotated 180° about an axis perpendicular to the longitudinal axis L1), then any air within the reservoir 46 will likely occupy the well 53 instead of liquid aerosol-generating material.

It should also be appreciated, that while FIG. 3a shows a relatively large part of the second surface 6b of the heater assembly 6 below the reservoir 46, in some implementations, the lower end of the air tube 52 may be flared outwards (i.e., in the direction towards the end of the heater assembly 6) to help improve contact between the heater assembly 6 and the lower support unit 7 (e.g., for improving the contact between the contact pad 75 and the heater assembly 6 to ensure appropriate electrical connection and/or improving the liquid seal between the reservoir 46 and the lower support unit 7).

Additionally, in some implementations, a wicking material, such as cotton or glass fibres, formed as a layer may be provided between the heater assembly 6 and the upper support unit 5, where the wicking material is in contact with the wells 53 and capable of transporting the liquid aerosol-generating material in the longitudinal direction. Additionally or alternatively, in some implementations, the heater assembly 6 may be formed from a porous substrate (such as a sintered material or a ceramic).

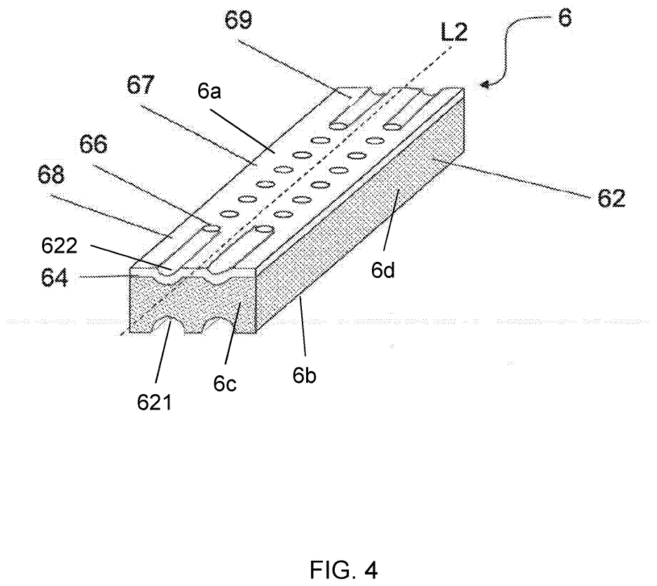

Turning now to the heater assembly 6, the heater assembly 6 is a microfluidic heater assembly. FIG. 4 schematically illustrates the microfluidic heater assembly 6 in more detail. FIG. 4 shows certain elements of the heater assembly 6 in an exaggerated manner for the purposes of aiding understanding of the features of the heater assembly 6.

The microfluidic heater assembly 6 comprises a substrate 62 and an electrically resistive layer 64 disposed on a surface of the substrate 62.

In this implementation, the substrate 62 is formed from a non-conductive material, such as quartz (silicon dioxide); however, it should be appreciated that other suitable non-conductive materials may be used, such as ceramics, for example. In such implementations, the material the substrate 62 is formed form may be considered substantially impermeable. However, in some implementations, the substrate 62 may be formed from or comprise a porous material. The porous substrate 62 may be formed from naturally porous materials, such as sponges, porous stones or ceramics etc., or via materials that are engineered to be porous, such as sintered metals or other materials. These materials, either formed naturally or engineered, have pores or hollow regions which are interconnected and define passages that follow a substantially random path through the material. The way in which the substrate 62 is formed and the materials it is made therefrom is not of primary significance to the principles of the present disclosure.

The electrically resistive layer 64 is formed from any suitable electrically conductive material, for example a metal or a metal alloy such as titanium or nickel chromium. The electrically resistive layer 64 may be formed on the surface of the substrate 62 in any suitable way. For example, the electrically resistive layer 64 may be provided as a film that is adhered or otherwise bonded to the surface of the substrate 62. Alternatively, the electrically resistive layer 64 may be formed though a deposition technique, such as chemical or vapour deposition. The way in which the electrically resistive layer 64 is formed and the materials it is made therefrom is not of primary significance to the principles of the present disclosure.

The heater assembly 6 is planar and in the form of a rectangular cuboidal block, elongate in the direction of a longitudinal axis L2. The heater assembly 6 has the shape of a strip and has parallel sides. The heater assembly 6 has parallel upper and lower major (planar) surfaces (first surface 6a and second surface 6b) and parallel side surfaces (fourth surface 6d) and parallel end surfaces (third surface 6c). The first surface 6a, one third surface 6c and one fourth surface 6d are shown in FIG. 4. In the shown implementation of FIG. 4, the length of the heater assembly 6 is 10 mm, its width is 1 mm, and its thickness is 0.12 mm (where the thickness of the substrate 62 is approximately 0.10 mm, and the thickness of the electrically resistive layer 64 is approximately 0.02 mm). The small size of the heater assembly 6 enables the overall size of the cartomiser 3 to be reduced and the overall mass of the components of the cartomiser to be reduced. However, it should be appreciated that in other implementations, the heater assembly 6 may have different dimensions and/or shapes depending upon the application at hand. For example, in some implementations, the heater assembly 6 may be a 3×3 mm chip.

Along the longitudinal axis L2, the heater assembly 6 has a central portion 67 and first and second end portions 68, 69. In FIG. 4, the length of the central portion 67 (relative to the lengths of the end portions 68, 69) has been exaggerated for reasons of visual clarity. When the vaporizer is in situ in the cartomiser, the central portion 67 is positioned in the air passage 73 and air passage 58. The central portion 67 extends across the top end of the air passage 73 of the lower support unit 7 and across the bottom end of the air passage 58 of the upper sealing unit 5. The end portions 68, 69 are positioned between the wells 53 of the upper sealing unit 5 and the lower support unit 7.

In the central portion 67 of the heater assembly 6, a plurality of capillary tubes 66 are provided. Only the openings of the capillary tubes 66 are shown in FIG. 4 (and in an exaggerated way for clarity), but the capillary tubes 66 extend from one side of the heater assembly 6 to the other. More specifically, the capillary tubes extend from the side of the heater assembly 6 opposite the electrically resistive layer 64 (the second surface 6b not shown in FIG. 4), through the substrate 62 toward the face of the substrate 62 on which the electrically resistive layer 64 is disposed, and then through the electrically resistive layer 64 (the first surface 6a).

The plurality of capillary tubes 66 extend substantially linearly through the heater assembly 6 (that is, the capillary tubes 66 follow substantially linear paths). By substantially, it is meant that the capillary tubes 66 follow pathways that are within 5%, within 2% or within 1% of a straight line. This measure may be obtained in any suitable way, e.g., by comparison of the length of the distance from a first point to a second point along the extent of the capillary tube 66 and the corresponding distance that the central axis of the capillary tube 66 extends between the same two points. The capillary tubes 66 are formed in the heater assembly 66 via a manufacturing process. That is to say, the capillary tubes 66 do not naturally exist in the substrate material 62 or electrically resistive layer 64, but rather, the capillary tubes 66 are formed in the substrate material 62 and electrically resistive layer 64 through a suitable process. A suitable process for forming the capillary tubes 66, particularly when forming capillary tubes that substantially follow a linear path, is laser drilling. However, any other suitable technique may be employed in order to generate the capillary tubes 66.

The capillary tubes 66 are configured so as to transport liquid from one surface of the heater assembly 6 (i.e., the second surface 6b) to the electrically resistive layer 64. The exact dimensions of the capillary tubes 66, and in particular the diameter, may be set in accordance with the liquid to be stored in the reservoir 46 of the cartomiser 3 and subsequently used with the heater assembly 6. For example, the properties of the liquid aerosol-generating material (e.g., viscosity) in the reservoir 46 of the cartomiser 3 may dictate the diameter of the capillary tubes 66 to ensure that a suitable flow of liquid is provided to the electrically resistive layer 64. However, in some implementations, the capillary tubes 66 may have a diameter on the order to tens of microns, e.g., between 10 μm to 250 μm, between 10 μm to 150 μm, or between 10 μm to 100 μm. However, it should be appreciated that capillary tubes 66 in other implementations may be set differently based on the properties of the liquid to be vaporised and/or a desired supply of liquid to the electrically resistive layer 64. Moreover, it should be appreciated that to achieve a desired level of flow to the electrically resistive layer 64, not only the diameter of the capillary tubes 66 but also the number/number per unit area of the capillary tubes 66 may also influence the supply of liquid to the electrically resistive layer 64.

In accordance with the principles of the present disclosure, the heater assembly 6 is provided with one or more distribution channels 621, 622. The distribution channels 621, 622 are provided on a surface of the substrate 62. In particular, the distribution channels 621, 622 are formed on a surface of the substrate 62, for example through machining, drilling, etching etc., and as such extend along a predetermined path on the surface of the substrate 62. The distribution channels 621, 622 are broadly configured to guide liquid, in particular liquid aerosol-generating material, along the pre-defined pathway across the surface of the substrate 62. Broadly, (liquid) aerosol-generating material present in the distribution channels 621, 622 is confined to movement along or across the surface of the substrate 62. In some implementations, the distribution channels 621, 622 may be provided to be in fluid communication with other flow paths, such as the capillary tubes 66, to allow movement of the liquid that is not constrained to the surface of the substrate 62.

FIG. 4 shows distribution channels 622 provided on a surface of the substrate 62 that comprises the electrically resistive layer 64 and distribution channels 621 provided on another surface of the substrate 62, in particular the surface corresponding to the second surface 6b of the heater assembly 6 that is opposite the first surface 6a of the heater assembly 6 (which is broadly parallel with the surface of the substrate 62 on which the electrically resistive layer 64 is disposed). The specific functions of the distribution channels 621, 622 may be different, but broadly speaking, the distribution channels 621, 622 are configured to guide liquid aerosol-generating material across the surface of the substrate 62, for example, to or from the one or more capillary tubes 66. In this regard, it should be understood that FIG. 4 shows distribution channels 621, 622 formed both on the surface of the substrate 62 that, in use, faces the reservoir 46 (corresponding to the second surface 6b of the heater assembly 6) and on the surface of the substrate 62 that, in use, faces the air channel 73 (parallel to the first surface 6a of the heater assembly 6). However, in some implementations, only distribution channels 621 on the surface of the substrate 62 that, in use, faces the reservoir 46 or only distribution channels 622 on the surface of the substrate 62 that, in use, faces the air channel 73 are provided.

The distribution channels 621, 622 are formed on a surface of the substrate 62. The distribution channels 621, 622 may be formed using any suitable technique. The distribution channels 621, 622 may be formed through subtractive manufacturing, for example, through etching, milling or drilling. In some implementations, the distribution channels 621, 622 are formed by laser drilling, whereby the centre of the laser beam is pointed at the edge of the substrate such that the beam axis is parallel to the surface of the substrate 62.

The distribution channels 621, 622 are configured to guide liquid aerosol-generating material along a predetermined path across the surface of the substrate 62. In particular, the distribution channels 621, 622 extend along a predetermined path and provide a channel (e.g., broadly including a base and side-walls) that acts to guide liquid aerosol-generating material along the predetermined path. The distribution channels 621, 622 may therefore be represented as grooves or recesses on the surface of the substrate 62. The distribution channels 621, 622 may have any suitable cross-sectional shape when viewed along the direction of extent of the distribution channels 621, 622. In some implementations, the cross-sectional shape is semi-circular or arced. That is to say, in some implementations, the distribution channels 621, 622 are formed as grooves extending from the capillary tubes 66 having a semi-circular or arced cross-sectional shape. The cross-sectional shape may be chosen so as to facilitate the transport of liquid aerosol-generating material along the predetermined path. It should be understood that for implementations where a plurality of distribution channels 621, 622 are provided, the shapes and/or extents of distribution channels 621, 622 may be the same or different. This includes distribution channels 621, 622 provided on the same surface of the substrate as one another, as well as distribution channels 621, 622 provided on different surfaces of the substrate 62.

In the example of FIG. 4, the distribution channels 621, 622 extend along respective predetermined paths that intersect a capillary tube 66. That is to say, in some implementations, the distribution channels 621, 622 extend from a respective capillary tube 66. In such implementations, the distribution channels 621, 622 are configured to transport liquid aerosol-generating material to or from the one or more capillary tubes 66. For example, liquid aerosol-generating material may flow from the opening of the capillary tube 66 and along the predefined path of distribution channel 622 provided on the surface of the substrate 62 that, in use, faces the air channel 73, or liquid aerosol-generating material may flow along the predefined path of distribution channel 621 provided on the surface of the substrate 62 that, in use, faces the reservoir 46 (corresponding to the second surface 6b of the heater assembly 6) to the opening of the capillary tube 66.

Moreover, in the example of FIG. 4, the distribution channels 621, 622 are shown extending from a respective capillary tube 66 to the edge of the heater assembly 6. Put another way, the distribution channels 621, 622 have an opening which is provided on a side surface of the heater assembly 6 or substrate 62 (e.g., corresponding to side surface 6c), and the distribution channels 621, 622 extend from the capillary tubes 66 to the side surface of the substrate 62.

However, and as will be described in more detail below, it should be appreciated that in accordance with the present disclosure, the distribution channels 621, 622 provided on either of the surface of the substrate 62 that, in use, faces the reservoir 46 (corresponding to the second surface 6b of the heater assembly 6) or the surface of the substrate 62 that, in use, faces the air channel 73 (parallel to the first surface 6a of the heater assembly 6), may be provided at any location on the respective surface of the substrate 62 and extend to any other location on the respective surface of the substrate 62. In some implementations, the distribution channels 621, 622 may extend from respective capillary tubes 66, such that liquid aerosol-generating material is capable of being guided along the predetermined path to the capillary tube 66 or from the capillary tube 66 and subsequently along the predetermined path. In some implementations, the distribution channels 621 formed on the surface of the substrate 62 that, in use, faces the reservoir 46 (corresponding to the second surface 6b of the heater assembly 6) are formed so as to extend from a respective capillary tube 66. In such implementations, the distribution channels 621 are provided to guide liquid aerosol-generating material to the respective capillary tube 66. Additionally, or alternatively, in some implementations, the distribution channels 621, 622 may extend to respective surfaces (or edges) of the substrate 62 (whereby the respective surfaces or edges are not either of the surface of the substrate 62 that, in use, faces the reservoir 46 (corresponding to the second surface 6b of the heater assembly 6) or the surface of the substrate 62 that, in use, faces the air channel 73 (parallel to the first surface 6a of the heater assembly 6)). In these implementations, liquid aerosol-generating material is capable of being guided along the predetermined path to or from the surface or edge of the substrate 62. In some implementations, the distribution channels 621 formed on the surface of the substrate 62 that, in use, faces the reservoir 46 (corresponding to the second surface 6b of the heater assembly 6) are formed so as to extend to respective surfaces (or edges) of the substrate 62 that are not either of the surface of the substrate 62 that, in use, faces the reservoir 46 (corresponding to the second surface 6b of the heater assembly 6) or the surface of the substrate 62 that, in use, faces the air channel 73 (parallel to the first surface 6a of the heater assembly 6). In such implementations, the distribution channels 621 are provided to guide liquid aerosol-generating material from the respective surface (or edges) of the substrate 62 that are not either of the surface of the substrate 62 that, in use, faces the reservoir 46 (corresponding to the second surface 6b of the heater assembly 6) or the surface of the substrate 62 that, in use, faces the air channel 73 (parallel to the first surface 6a of the heater assembly 6). In some alternative implementations, the distribution channels 621, 622 extend only part way to the surface of the substrate 62 and/or part way to the capillary tubes 66.

The distribution channels 621, 622 extend along the surface of the substrate 62. That is to say, the distribution channels 621, 622 extend along a direction that is parallel or substantially parallel to the plane of the surface of the substrate 62. Additionally, the distribution channels 621, 622 extend along a direction that is substantially perpendicular (or perpendicular) to the direction of extent of the capillary tubes 66. Although FIG. 4 shows the distribution channels 622 extending parallel to the longitudinal axis L2 of the heater assembly 6, the distribution channels 622 (and distribution channels 621) may extend in a direction that is not parallel to the longitudinal axis L2 of the heater assembly 6. For example, the distribution channel 622 may extend from a corner of the first surface 6a of the heater assembly 6 along a direction approximately 45° to the longitudinal axis L2. However, in accordance with the present disclosure, the distribution channels 621, 622 extend along a direction that is parallel to the plane of the surface of the substrate 62. Moreover, the distribution channels 621, 622 extend along a predetermined path across the surface of the substrate 62, whereby the predetermined path is parallel to the surface of the substrate 62 (although, as discussed in more detail below, the direction the predetermined path extends may vary along the length of the predetermined path).

Additionally, FIG. 4 shows the distribution channels 621, 622 as having a width that is approximately equal to the width or diameter of the capillary tubes 66. In some implementations, this may mean that the distribution channels 621, 622 exhibit a similar capillary effect on the liquid aerosol-generating material as the capillary tubes 66. However, it should be appreciated that in other implementations, the width of the distribution channels 621, 622 may be greater or smaller than the width/diameter of the capillary tubes 66, which may in part be based on the function of the distribution channels 621, 622. In addition, in some implementations, the width of the distribution channels 621, 622 may vary as a function of distance—for example, in some implementations, the width of the distribution channel 622 may increase further from the capillary tube 66, thereby providing a V-shaped distribution channel with the point of the V-shape approximately aligned with the capillary tube 66. Hence, the specific shape and/or width of the distribution channel 621, 622 may be different depending on the implementation at hand.

Additionally, FIG. 4 shows the distribution channels 621, 622 as having a depth that is approximately half the width or diameter of the capillary tubes 66. Depth, in this instance, refers to the distance below the surface of the substrate 62, typically defined by the surface of the distribution channel 621, 622. However, it should be appreciated that in other implementations, the depth of the distribution channels 621, 622 may be greater or smaller than half the width/diameter of the capillary tubes 66, which may in part be based on the function of the distribution channels 621, 622. Hence, the specific shape and/or depth of the distribution channel 621, 622 may be different depending on the implementation at hand.

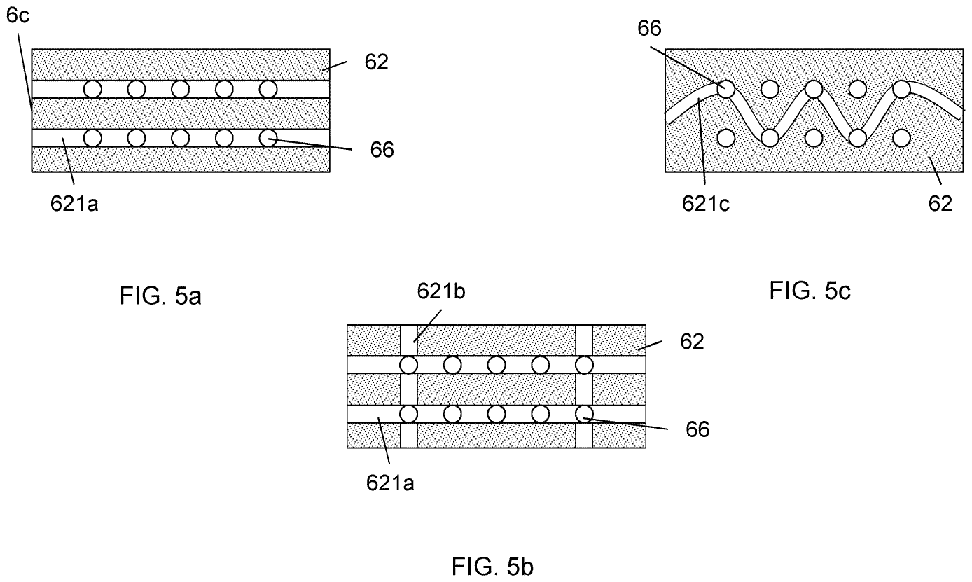

FIGS. 5a to 5c schematically show different implementations of the distribution channels 621 provided on the surface of the substrate 62 that faces the reservoir 46 (corresponding to the second surface 6b of the heater assembly 6). FIGS. 5a to 5c show a view of the heater assembly 6 from underneath, i.e., looking at the second surface 6b of the heater assembly 6. FIGS. 5a to 5c will be understood from FIG. 4.

FIGS. 5a to 5c show distribution channels 621a, 621b, 621c provided on the surface of the substrate 62. This surface of the substrate 62 is intended to be in direct fluid communication with the liquid aerosol-generating material in the reservoir 46 of the cartomiser 3. The main function of the distribution channels 621 to 621c is to supply liquid aerosol-generating material to the capillary tubes 66 (or the openings thereof). Accordingly, in the shown implementation, the distribution channels 621 to 621c formed on the surface of the substrate 62 that, in use, faces the reservoir 46 (corresponding to the second surface 6b of the heater assembly 6) are formed so as to extend to or from a respective capillary tube 66. In such implementations, the distribution channels 621 to 621c are provided to guide liquid aerosol-generating material to the respective capillary tube 66. In other words, the distribution channels 621 to 621c help facilitate the wicking or transport of liquid aerosol-generating material to the capillary tubes 66 so that the liquid aerosol-generating material can be supplied to the electrically resistive layer 64 via the capillary tubes 66. The distribution channels 621 to 621c may therefore be sized and dimensioned to help facilitate the wicking of the liquid, for example, by having a width and/or depth that enables capillary forces to act on liquid aerosol-generating material within the distribution channels 621 to 621c.

Providing the distribution channels 621 to 621c on the surface of the substrate that is in contact with the liquid aerosol-generating material in the reservoir 46 can help aid the transport of liquid aerosol-generating material, firstly, to the capillary tubes 66 and, secondly, to the electrically resistive layer 64. This may lead to more liquid aerosol-generating material being transported to the electrically resistive layer 64 per second, thereby enabling the electrically resistive layer 64 to generate more aerosol per second for a given energy supplied to the electrically resistive layer 64. Alternatively, or additionally, the distribution channels 621 to 621c may be capable of providing a consistent supply of liquid aerosol-generating material to the electrically resistive layer 64 (for example, when the rate of vaporisation is increased, e.g., due to more power being supplied to the electrically resistive layer, the distribution channels 621 to 621c may be capable of supplying liquid to the electrical resistive layer 64 at a consistent rate).

Turning to FIG. 5a, FIG. 5a shows a first example of distribution channels 621a provided on the surface of the substrate 62 that is intended to be in contact with the reservoir 46. In FIG. 5a, broadly two distribution channels 621a are shown which extend from one end surface of the substrate to another end surface of the substrate (where the end surfaces each correspond to the third surface 6c of the heater assembly 6). The distribution channels 621a extend over a plurality of capillary tube openings—for example, in FIG. 5a, one distribution channel 621a extends over five capillary tube openings. In this example of FIG. 5a, it may be said that each capillary tube 66 has at least one distribution channel that extends therefrom and, in this example, each distribution channel is aligned to provide a continuous distribution channel 621a extending from left to right of the substrate 62. It should be appreciated that the distribution and number of capillary tubes 66 shown in FIG. 5a is an example only, and in practical implementations, there may be more or fewer capillary tubes 66 in the heater assembly 6. Additionally, it should be understood that although FIG. 5a shows each and every capillary tube 66 being provided in fluid communication with a distribution tube 621a, in some implementations, not every capillary tube 66 is provided in fluid communication with a distribution channel 621a.

The distribution channel 621a essentially passes sequentially to each of the capillary tubes 66 that the distribution channel 621a extends over. Accordingly, liquid that enters the distribution channel 621a is able to be passed to the capillary tube openings when the liquid follows the predetermined path of the distribution channel 621a. For example, liquid that enters from the left-hand side of the heater assembly 6 of FIG. 5a, first passes to the leftmost capillary tube 66 and, if this is full of liquid and/or the rate of flow of the liquid along the distribution channel 621a is sufficient, some of the liquid may pass to the next leftmost capillary tube 66 and so on. The distribution tube 621a is therefore capable of providing liquid to the capillary tubes 66 the distribution channel 621a extends from.

In the particular example of FIG. 5a, the distribution channel 621a has at least a part that extends from one capillary tube 66 to the side surface of the substrate 62/heater assembly 6, and in particular, this is the third surface 6c of the heater assembly 6. That is, the distribution channels 621a formed on the surface of the substrate 62 that, in use, faces the reservoir 46 (corresponding to the second surface 6b of the heater assembly 6) are formed so as to extend to respective surfaces (or edges) of the substrate 62 that are not either of the surface of the substrate 62 that, in use, faces the reservoir 46 (corresponding to the second surface 6b of the heater assembly 6) or the surface of the substrate 62 that, in use, faces the air channel 73 (parallel to the first surface 6a of the heater assembly 6). In this case, not only do the distribution channels 621a aim to channel liquid that contacts the second surface 6b of the substrate 62/heater assembly 6, but the distribution channels 621a also aim to channel liquid that contacts the third surface 6c of the heater assembly 6 to the capillary tubes 66. With reference back to FIGS. 3a and 3b, the elongated recess in the foot 51 provides an opening which exposes the ends of the heater assembly 6, and in particular the third surface 6c of the heater assembly 6. (The third surface is defined by the width and thickness of the heater assembly 6 in this example). Hence, by providing the distribution channels 621a in the surface of the substrate 62 that faces the reservoir 46, the degree of wicking or supply of liquid to the capillary tubes 66 can be improved.

In the example of FIG. 5a, the distribution channel 621a extends the length of the heater assembly 6. However, it should be appreciated that this may not be the case in other implementations. For example, in a similar fashion to the distribution channels 622 shown in FIG. 4, the distribution channel 621a may only extend from one capillary tube 66, and/or the distribution channel 621a may extend only between certain capillary tubes 66.

FIG. 5a shows an example where the distribution channels 621a follow a linear path along a first direction (namely, a direction parallel to the longitudinal axis L2 of the heater assembly 6). FIG. 5b is a second example of a substrate 62 comprising distribution channels 621b which are provided following a linear path along a second direction (namely, a direction perpendicular to the longitudinal axis L2 of the heater assembly 6).

Turning to FIG. 5b, FIG. 5b shows a second example of distribution channels 621b provided on the surface of the substrate 62 that is intended to be in contact with the reservoir 46. In FIG. 5b, the two distribution channels 621a of FIG. 5a are shown. However, FIG. 5b also shows two distribution channels 621b which extend from one side surface of the substrate to another side surface of the substrate (where the side surfaces each correspond to the fourth surface 6d of the heater assembly 6). The distribution channels 621b extend over a plurality of capillary tube openings—for example, in FIG. 5b, one distribution channel 621b extends over two capillary tube openings. In this example of FIG. 5b, the leftmost capillary tubes 66 and rightmost capillary tubes 66 additionally are provided with the distribution channels 621b that follow a linear path that is different from the linear path that distribution channels 621a follow. As with FIG. 5a, it should be appreciated that the distribution and number of capillary tubes 66 shown in FIG. 5b is an example only, and in practical implementations, there may be more or fewer capillary tubes 66 in the heater assembly 6.

The distribution channel 621b essentially acts as an additional channel for supplying liquid aerosol-generating material to select capillary tubes 66 (although it should be appreciated that any liquid supplied by distribution channel 621b to a capillary tube 66 may be supplied to the distribution channel 621a, and then to other capillary tubes 66 fluidly connected to the distribution channel 621a).

In the particular example of FIG. 5b, the distribution channel 621b has at least a part that extends from one capillary tube 66 to the side surface of the substrate 62/heater assembly 6, and in particular, this is the fourth surface 6d of the heater assembly 6. That is, the distribution channels 621b formed on the surface of the substrate 62 that, in use, faces the reservoir 46 (corresponding to the second surface 6b of the heater assembly 6) are formed so as to extend to respective surfaces (or edges) of the substrate 62 that are not either of the surface of the substrate 62 that, in use, faces the reservoir 46 (corresponding to the second surface 6b of the heater assembly 6) or the surface of the substrate 62 that, in use, faces the air channel 73 (parallel to the first surface 6a of the heater assembly 6). In this case, not only do the distribution channels 621b further aim to channel liquid that contacts the second surface 6b of the substrate 62/heater assembly 6, but the distribution channels 621b also aim to channel liquid that contacts the fourth surface 6d of the heater assembly 6 to the capillary tubes 66. With reference back to FIGS. 3a and 3b, the elongated recess in the foot 51 provides an opening which exposes the side surfaces of ends of the heater assembly 6, and in particular a portion of the fourth surface 6d of the heater assembly 6. (The fourth surface is defined by the length and thickness of the heater assembly 6 in this example). Hence, by providing the distribution channels 621b in the surface of the substrate 62 that faces the reservoir 46, the degree of wicking or supply of liquid to the capillary tubes 66 can be improved.

In the example of FIG. 5b, the distribution channel 621b extends the width of the heater assembly 6. However, it should be appreciated that this may not be the case in other implementations. For example, in a similar fashion to the distribution channels 622 shown in FIG. 4, the distribution channel 621b may only extend from one capillary tube 66, and/or the distribution channel 621b may extend only between certain capillary tubes 66.

In FIG. 5b, both the distribution channels 621a and 621b are provided on the surface of the substrate 62. However, it should be appreciated that in other implementations, the distribution channels 621a may not be provided. That is to say, in these examples, the distribution channels 621b are arranged to allow liquid to (additionally) be fed from the side of the heater assembly 6 to the capillary tubes 66.

Specifically, it should be appreciated at any desired combination of distribution channels 621a following a first linear path parallel to the longitudinal axis of the heater assembly and/or distribution channels 621b following a second linear path perpendicular to the longitudinal axis of the heater assembly 6 may be implemented depending upon the application at hand and which ones (which may include all) of the capillary tubes 66 are desired to be selectively provided with distribution channels to aid the supply of liquid to these selected capillary tubes 66. Each capillary tube 66 may have none, one or more distribution channels extending therefrom and broadly in a direction towards one of the side surfaces (e.g., side surface 6d or end surface 6c) of the heater assembly 6. The way in which distribution channels are provided for any given application may in part be dependent on the configuration of the cartomiser 3 and the heater assembly 6.

The distribution channels 621a and 621b are shown in FIGS. 5a and 5b as extending along directions that are either parallel to or perpendicular to the longitudinal axis of the heater assembly 6. However, it should be appreciated that distribution channels may be provided that follow a linear path that is provided at another angle to the longitudinal axis of the heater assembly, e.g., 45°. In some implementations, particularly where the ends of the heater assembly 6 are exposed to the reservoir 46 (e.g., such as in the wells 53 of FIGS. 3a and 3b), an array of distribution channels may be provided extending along straight lines at various angles to the longitudinal axis from the capillary tubes 66 to the edges of the substrate 62 (e.g., providing a handheld fan-shaped arrangement of the distribution channels).

FIGS. 5a and 5b show distribution channels 621a and 621b that extend along broadly linear predetermined paths. However, in some implementations, the distribution channels may follow a curved and/or zig-zag predetermined path. FIG. 5c is a third example of a substrate 62 comprising distribution channels 621c which are provided following a curved and/or zig-zag predetermined path.

Turning to FIG. 5c, FIG. 5c shows a third example of distribution channels 621c provided on the surface of the substrate 62 that is intended to be in contact with the reservoir 46. In FIG. 5c, a single distribution channel 621c is provided that starts at one end surface of the substrate 62/heater assembly 6 and extends to the other end surface of the substrate 62/heater assembly 6. However, in this example, the pathway that the distribution channel 621c follows varies with respect to the longitudinal axis of the heater assembly 6 as the distribution channel progresses from the left-hand to the right-hand side of the heater assembly 6.

More particularly, the distribution channel 621c follows a curved path which zig-zags between select capillary tubes 66. Accordingly, select capillary tubes 66 that overlap with the distribution channel 621c are able to be supplied with liquid from the distribution channel 621c, in a similar manner to as described above with respect to FIGS. 5a and 5b. As with FIGS. 5a and 5b, it should be appreciated that the distribution and number of capillary tubes 66 shown in FIG. 5c is an example only, and in practical implementations, there may be many more capillary tubes 66 in the heater assembly 6.

In the particular example of FIG. 5c, the distribution channel 621c has at least a part that extends from one capillary tube 66 to the end surface of the substrate 62/heater assembly 6, and in particular, this is the third surface 6c of the heater assembly 6. The distribution channel 621c is similar to the distribution channel 621a in this regard, in that the distribution channel 621c is provided with an opening on the end surface, the third surface 6c, of the substrate 62/heater assembly 6.

Although FIG. 5c shows a distribution channel 621c that follows a curved and zig-zag path, it should be understood that in some implementations, this is not the case. For example, the distribution channel 621c may follow a linear zig-zag path, whereby each section of the zig-zag path is linear. Alternatively, the distribution channel 621c may not follow a zig-zag path, and may instead follow a curved path.

The precise configuration of the distribution channels 621 to 621c may depend on the application at hand. For example, for a given heater assembly 6 in a given cartomiser 3, it may be found that supply of liquid aerosol-generating material to certain ones of the capillary tubes 66 and from certain directions along the surface of the substrate 62 may provide certain effects in terms of the efficiency of wicking and/or the generation of aerosol in respect of the given heater assembly 6. Accordingly, in some applications, certain combinations and distributions of the distribution channels 621 to 621c may be more suited than in other applications. For example, in some applications, it may be desired to supply liquid to the capillary tubes 66 that are provided in the centre of the heater assembly 6, and as such a combination of suitable distribution channels 621 to 621c may be provided to enable the preferential supply of liquid to the centre of the heater assembly 6. Empirical testing or computer modelling may be used to determine suitable configurations of the distribution channels 621 to 621c for a given application.

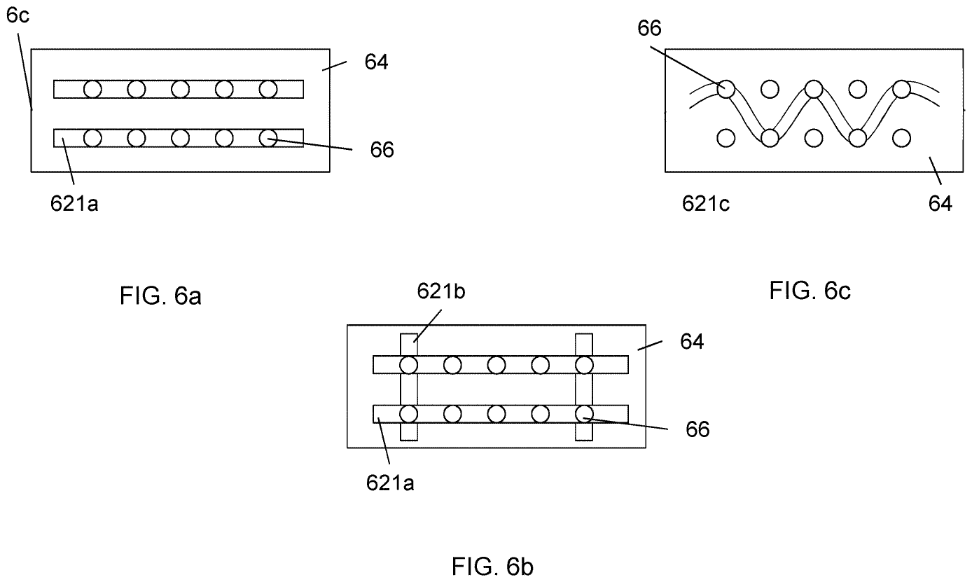

In addition, it should be appreciated that in respect of the supply of liquid aerosol-generating material, the distribution channels 621 to 621c extend from one or more capillary tubes 66. That is to say, distribution channels 621 to 621c formed on the surface of the substrate 62 that, in use, faces the reservoir 46 (corresponding to the second surface 6b of the heater assembly 6) are formed so as to extend from the one or more capillary tubes 66. In this way, the distribution channels 621 to 621c may act to supply liquid to the capillary tubes 66 for supply to the electrically resistive layer 64. However, it should be appreciated that this may not necessarily be the case in all implementations. For example, if the substrate 62 is formed from a material that includes a porous structure capable of permitting liquid flow along the length of the substrate 62, then the distribution channels 621 to 621c may not extend from the capillary tubes 66. In such implementations, the distribution channels 621 to 621c may act to guide liquid to certain parts of the porous substrate 62 (for example towards a central portion of the substrate 62), whereby the interconnected pores of the substrate 62 are capable of supplying the liquid aerosol-generating material to the capillary tubes 66 via a random path. FIGS. 6a to 6c schematically show different implementations of the distribution channels 622 provided on the surface of the substrate 62 on which the electrically resistive layer 64 is disposed. This surface of the substrate 62 is broadly parallel with the second surface 6b of the heater assembly 6, noting that the second surface of the heater assembly 6 is the surface of the electrically resistive layer 64. FIGS. 6a to 6c show a view of the heater assembly 6 from above, i.e., looking at the first surface 6a of the heater assembly 6. FIGS. 6a to 6c will be understood from FIG. 4.

FIGS. 6a to 6c show distribution channels 622a, 622b, 622c provided on the surface of the substrate 62/surface of the heater assembly 6. As can be seen best in FIG. 4, the electrically resistive layer 64 is disposed on the surface of the substrate 62 and therefore when the surface of the substrate 62 is formed with one or more distribution channels 622 to 622c thereon, the electrically resistive layer 64 essentially lines the one or more distribution channels 622 to 622c formed on the surface of the substrate 62. Accordingly, the distribution channels 622 to 622c are not only formed in the surface of the substrate 62 on which the electrically resistive layer 64 is disposed, but the distribution channels 622 to 622c are also formed in the electrically resistive layer 64.

As noted above, the electrically resistive layer 64 of the heater assembly is not intended to come into direct contact with the liquid aerosol-generating material in the reservoir 46 of the cartomiser 3. Therefore, the function of the distribution channels 622 to 622c is different to the function of the distribution channels 621 to 621c. In particular, the distribution channels 622 to 622c are provided for one of two main functions (or both main functions).

On the one hand, the distribution channels 622 to 622c are provided to help facilitate the distribution of liquid from the capillary tubes 66 (or the openings thereof in the electrically resistive layer 64) across the electrically resistive layer 64. That is, liquid aerosol-generating material that is fed, by capillary action, along the capillary tubes 66 to the opening in the electrically resistive layer 64 is then able to be distributed, by the distribution channels 622 to 622c to different parts of the electrically restive layer 64. Without the distribution channels 622 to 622c, in some instances, liquid may pool at or around the opening of the capillary tube 66 until such a time as the liquid is heated by the electrically resistive layer 64 and vaporises. The greater the size of the droplet that pools at the opening of the capillary tube 66, the greater the energy needed to vaporiser the droplet. For a given amount of energy supplied to the heater assembly 6, this may equate to a greater time required to vaporise the droplet. However, providing the distribution channels 622 to 622c, which are configured so as to transport liquid away from the opening of the capillary tube 66 in the electrically resistive layer 64, the liquid supplied to the electrically resistive layer 64 can be more evenly distributed across the electrically resistive layer 64. In particular, when the distribution channels 622 to 622c contain the electrically resistive layer 64, the distribution channels 622 to 622c may also directly vaporise the liquid that is wicked away from the opening of the capillary tubes 66 by virtue of the presence of the electrically resistive layer 64. In other words, the distribution channels 622 to 622c may help facilitate the wicking or transport of liquid aerosol-generating material from the capillary tubes 66 so that the liquid aerosol-generating material can be more evenly distributed across the electrically resistive layer 64 and vaporised. This may lead to more consistent and/or quicker vaporisation of the liquid aerosol-generating material. The distribution channels 622 to 622c may therefore be sized and dimensioned to help facilitate the wicking of the liquid, for example, by having a width and/or depth that enables capillary forces to act on liquid aerosol-generating material within the distribution channels 622 to 622c. The distribution channels 622 to 622c may have a width that is equal to or less than the width or diameter of the opening of the capillary tubes 66 in the electrically resistive layer 64.

On the other hand, the distribution channels 622 to 622c may, additionally or alternatively, be configured to allow condensed liquid (i.e., liquid which has previously been vaporised by the electrically resistive layer 64 but which did not escape the cartomiser 3 and has subsequently cooled to return back to a liquid state) to be transported across the surface of the substrate 62 and/or electrically resistive layer 64. In some implementations, the distribution channels 622 to 622c also extend to the openings of the capillary tubes 66. Accordingly, condensed liquid deposited on the surface of the electrically resistive layer 64 may be recycled and returned back to the capillary tubes 66 and/or collected within the distribution channels 622 to 622c for vaporisation an additional time. In this way, not only may condensed liquid be recycled to thereby reduce wastage and potentially improve the longevity of a cartomiser 3, even if marginally, but also any condensed liquid that is caught by the distribution channels 622 to 622c may be prevented from exiting the cartomiser 3, e.g. along the air channel 58 and thereby leaking out of the cartomiser 3. The distribution channels 622 to 622c may therefore be sized and dimensioned to help facilitate the wicking of the liquid, for example, by having a width and/or depth that enables capillary forces to act on liquid aerosol-generating material within the distribution channels 622 to 622c. The distribution channels 622 to 622c may have a width that is equal to or less than the width or diameter of the opening of the capillary tubes 66 in the electrically resistive layer 64.

It should be understood that in order for a distribution channel 622 to 622c to perform the function of distributing liquid aerosol-generating material across the electrically resistive layer 64, the distribution channels 622 to 622c are provided extending from a respective capillary tube 66. In this way, the respective capillary tube 66 is in fluid communication with the distribution channel 622 to 622c such that liquid aerosol-generating material is able to flow along the distribution channel 622 to 622c when it exits the capillary tube 66. However, in some implementations, when the substrate 62 is formed from a porous material and the distribution channels 622 to 622c are not lined with the electrically resistive layer 64, then the distribution channels 622 to 622c may be provided such that they do not extend from the capillary tubes 66. In such implementations, liquid aerosol-generating material may be provided to the distribution channels 622 to 622c from the porous substrate 62, and subsequently is capable of flowing along the distribution channels 622 to 622c and across the surface of the substrate 62, to thereby bring the liquid into close contact with different regions of the electrically resistive layer 64.

Conversely, it should be understood that in order for a distribution channel 622 to 622c to perform the function of collecting condensed liquid aerosol-generating material, the distribution channels 622 to 622c may optionally extend from a respective capillary tube 66. However, there is no necessity for the distribution channels 622 to 622c to extend from a respective capillary tube 66 in order to perform this function. This is regardless of whether or not the distribution channels 622 to 622c are lined with the electrically resistive layer 64 or whether the substrate 62 is porous or not.

Thus, broadly speaking, the distribution channels 622 to 622c formed on the surface of the substrate 62 onto which the electrically resistive layer 64 is disposed (and therefore also present on the electrically resistive layer 64) are capable of distributing liquid aerosol-generating material across the electrically resistive layer 64 to thereby promote vaporisation of the aerosol-generating material and/or of returning condensed liquid to the openings of the capillary tubes 66 or retaining condensed liquid within the distribution channels 622 to 622c to thereby reduce wastage and/or reduce liquid leakage out of the cartomiser 3. Any given implementation of the distribution channels 622 to 622c in the heater assembly 6 may be configured to effect either one or both of these functions.

Turning to FIG. 6a, FIG. 6a shows a first example of distribution channels 622a provided on the surface of the substrate 62 on which the electrically resistive layer 64 is disposed. In FIG. 6a, broadly two distribution channels 622a are shown which extend from one end surface of the substrate to another end surface of the substrate (where the end surfaces each correspond to the third surface 6c of the heater assembly 6). The distribution channels 622a extend over a plurality of capillary tube openings—for example, in FIG. 6a, one distribution channel 622a extends over five capillary tube openings. In this example of FIG. 6a, it may be said that each capillary tube 66 has at least one distribution channel that extends therefrom and, in this example, each distribution channel is aligned to provide a continuous distribution channel 622a extending from left to right of the substrate 62. It should be appreciated that the distribution and number of capillary tubes 66 shown in FIG. 6a is an example only, and in practical implementations, there may be more or fewer capillary tubes 66 in the heater assembly 6. Additionally, it should be understood that although FIG. 6a shows each and every capillary tube 66 being provided in fluid communication with a distribution tube 622a, in some implementations, not every capillary tube 66 is provided in fluid communication with a distribution channel 622a. Indeed, in some further implementations, the distribution channel 622a may extend between two locations on the surface of the substrate 62 that do not correspond to an opening of a capillary tube 66 or a side edge/surface of the substrate 62.

The distribution channel 622a of the shown example passes sequentially to each of the capillary tubes 66 that the distribution channel 622a extends over. Accordingly, liquid that exits the capillary tube openings is able to flow into and along the predetermined path of the distribution channel 622a. For example, liquid that exits from the capillary tube 66 on the left-hand side of the heater assembly 6 of FIG. 6a is able to flow to the left and right of the capillary tube opening along the distribution channel 622a. The distribution channel 622a is therefore capable of allowing liquid to flow from the capillary tubes 66 along the corresponding distribution channel 622a. Additionally or alternatively, as described above, condensed liquid may travel along the distribution channel 622a to the capillary tube openings.

In the particular example of FIG. 6a, the distribution channel 622a has at least a part that extends from one capillary tube 66 in the direction of the side surface of the substrate 62/heater assembly 6, and in particular, this extends in the direction towards the third surface 6c of the heater assembly 6. Unlike the distribution channel 621a of FIG. 5a, the distribution channel 622a of FIG. 6a does not extend completely to the edge of the heater assembly 6 but instead stops prior to reaching the edge/third surface 6c. This is because, with reference to FIG. 3a, the electrically resistive layer 64 of the heater assembly 6 is pressed against the top surface 71 of the lower support unit 7 and forms a seal therewith that prevents liquid from the wells 53 from bypassing the capillary tubes 66 and contacting the electrically resistive layer 64 directly. Accordingly, preventing the distribution channels 622a from extending to the edges/surface of the heater assembly 6 may help direct liquid through the capillary tubes 66 to the electrically resistive layer 64. However, in some implementations, such as shown in FIG. 4 with the distribution channels 622, the distribution channels 622 may extend to the edge/side surface (third surface 6c) of the heater assembly 6. In such instances, liquid may be permitted to flow along the distribution channels 622 from the surface 6c. It should also be appreciated that in other implementations, e.g., when the entire electrically resistive layer 64 of heater assembly 6 is exposed to an airflow path, whether the distribution tubes 622 or 622 extend to the surface 6c or not is not significant, and may substantially be influenced by the aerosol generating performance of the distribution channels 622, 622a.

In the example of FIG. 6a, the distribution channel 622a extends substantially the length of the heater assembly 6. However, it should be appreciated that this may not be the case in other implementations. For example, in a similar fashion to the distribution channels 622 shown in FIG. 4, the distribution channel 622a may only extend from one capillary tube 66, and/or the distribution channel 622a may extend only between certain capillary tubes 66.

FIG. 6a shows an example where the distribution channels 622a follow a linear path along a first direction (namely, a direction parallel to the longitudinal axis L2 of the heater assembly 6). FIG. 6b is a second example of a substrate 62 comprising distribution channels 622b which are provided following a linear path along a second direction (namely, a direction perpendicular to the longitudinal axis L2 of the heater assembly 6).

Turning to FIG. 6b, FIG. 6b shows a second example of distribution channels 622b provided on the surface of the substrate 62 on which the electrically resistive layer 64 is disposed. In FIG. 6b, the two distribution channels 622a of FIG. 6a are shown. However, FIG. 6b also shows two distribution channels 622b which extend along a direction from one side surface of the substrate to another side surface of the substrate (where the side surfaces each correspond to the fourth surface 6d of the heater assembly 6). As with distribution channels 622a, the distribution channels 622b do not extend all the way to the edges/surface 6d of the heater assembly 6. The distribution channels 622b extend over a plurality of capillary tube openings—for example, in FIG. 6b, one distribution channel 622b extends over two capillary tube openings. In this example of FIG. 6b, the leftmost capillary tubes 66 and rightmost capillary tubes 66 additionally are provided with the distribution channels 622b that follow a linear path that is different from the linear path that distribution channels 622a follow. As with FIG. 6a, it should be appreciated that the distribution and number of capillary tubes 66 shown in FIG. 6b is an example only, and in practical implementations, there may be more or fewer capillary tubes 66 in the heater assembly 6.

The distribution channel 622b essentially acts as an additional channel for distributing liquid aerosol-generating material from select capillary tubes 66 or for distributing condensed liquid aerosol-generating material to the select capillary tubes 66.

In the particular example of FIG. 6b, the distribution channel 622b has at least a part that extends from one capillary tube 66 in the direction of the side surface of the substrate 62/heater assembly 6, and in particular, this is in the direction of the fourth surface 6d of the heater assembly 6. In this case, the distribution channels 622b further aim to channel liquid away from the capillary tubes 66 and across the electrically resistive layer 64. In the example of FIG. 6b, the distribution channel 622b extends slightly less than the width of the heater assembly 6. However, it should be appreciated that this may not be the case in other implementations. For example, in a similar fashion to the distribution channels 622 shown in FIG. 4, the distribution channel 622b may only extend from one capillary tube 66, and/or the distribution channel 622b may extend only between certain capillary tubes 66. Equally, in some implementations, the distribution channel 622b may extend to the edge/surface 6d of the heater assembly 6, as discussed in relation to distribution channels 622a above.

In FIG. 6b, both the distribution channels 622a and 622b are provided on the surface of the substrate 62. However, it should be appreciated that in other implementations, the distribution channels 622a may not be provided.

Specifically, it should be appreciated at any desired combination of distribution channels 622a following a first linear path parallel to the longitudinal axis of the heater assembly and/or distribution channels 622b following a second linear path perpendicular to the longitudinal axis of the heater assembly 6 may be implemented depending upon the application at hand and which ones (which may include all) of the capillary tubes 66 are desired to be selectively provided with distribution channels to aid the distribution of liquid from these selected capillary tubes 66. Each capillary tube 66 may have none, one or more distribution channels extending therefrom and broadly in a direction towards one of the side surfaces (e.g., side surface 6d or end surface 6c) of the heater assembly 6. The way in which distribution channels are provided for any given application may in part be dependent on the configuration of the cartomiser 3 and the heater assembly 6.

The distribution channels 622a and 622b are shown in FIGS. 6a and 6b as extending along directions that are either parallel to or perpendicular to the longitudinal axis of the heater assembly 6. However, it should be appreciated that distribution channels may be provided that follow a linear path that is provided at another angle to the longitudinal axis of the heater assembly, e.g., 45°. In some implementations, an array of distribution channels may be provided extending along straight lines at various angles to the longitudinal axis from a given one or more capillary tube openings in the directions towards the edges of the substrate 62 (e.g., providing a handheld fan-shaped arrangement of the distribution channels).

FIGS. 6a and 6b show distribution channels 622a and 622b that extend along broadly linear predetermined paths. However, in some implementations, the distribution channels may follow a curved and/or zig-zag predetermined path. FIG. 6c is a third example of a substrate 62 comprising distribution channels 622c which are provided following a curved and/or zig-zag predetermined path.

Turning to FIG. 6c, FIG. 6c shows a third example of distribution channels 622c provided on the surface of the substrate 62 on which the electrically resistive layer 64 is disposed. In FIG. 6c, a single distribution channel 622c is provided that starts close to one end surface of the substrate 62/heater assembly 6 and extends to a position close to the other end surface of the substrate 62/heater assembly 6. However, in this example, the pathway that the distribution channel 622c follows varies with respect to the longitudinal axis of the heater assembly 6 as the distribution channel progresses from the left-hand to the right-hand side of the heater assembly 6.

More particularly, the distribution channel 622c follows a curved path which zig-zags between select capillary tubes 66. Accordingly, select capillary tubes 66 that overlap with the distribution channel 622c are able to distribute any supplied liquid along the distribution channel 622c, in a similar manner to as described above with respect to FIGS. 6a and 6b. As with FIGS. 6a and 6b, it should be appreciated that the distribution and number of capillary tubes 66 shown in FIG. 6c is an example only, and in practical implementations, there may be many more capillary tubes 66 in the heater assembly 6.

In the particular example of FIG. 6c, the distribution channel 622c has at least a part that extends from one capillary tube 66 towards the end surface of the substrate 62/heater assembly 6, and in particular, this is in a direction towards the third surface 6c of the heater assembly 6. The distribution channel 622c is similar to the distribution channel 622a in this regard.

Although FIG. 6c shows a distribution channel 622c that follows a curved and zig-zag path, it should be understood that in some implementations, this is not the case. For example, the distribution channel 622c may follow a linear zig-zag path, whereby each section of the zig-zag path is linear. Alternatively, the distribution channel 622c may not follow a zig-zag path, and may instead follow a curved path.

The precise configuration of the distribution channels 622 to 622c may depend on the application at hand. For example, for a given heater assembly 6 in a given cartomiser 3, it may be found that supply of liquid aerosol-generating material from certain ones of the capillary tubes 66 and from certain directions along the surface of the substrate 62 may provide certain effects in terms of the efficiency of wicking and/or the generation of aerosol in respect of the given heater assembly 6. Accordingly, in some applications, certain combinations and distributions of the distribution channels 622 to 622c may be more suited than in other applications. For example, in some applications, it may be desired to supply liquid to the capillary tubes 66 that are provided in the centre of the heater assembly 6, and as such a combination of suitable distribution channels 622 to 622c may be provided to enable the preferential supply of liquid from the centre of the heater assembly 6 along the electrically resistive layer 64. Empirical testing or computer modelling may be used to determine suitable configurations of the distribution channels 622 to 622c for a given application.

It has been described that the electrically resistive layer 64 is disposed in the distribution channels 622 to 622c. However, in some implementations, the electrically resistive layer 64 may not be present in the distribution channels 622 to 622c. For example, the distribution channels 622 to 622c may be formed after the electrically resistive layer 64 has been disposed on the substrate 62, and therefore the removal of the material to provide the distribution channels includes removal of the electrically resistive layer 64 in this region. While the distribution channels 622 to 622c themselves may not be directly responsible for heating the liquid aerosol-forming material in this implementation, the distribution channels nonetheless are nonetheless in close proximity to the electrically resistive layer 64 (this layer essentially follows alongside the grooves cut into the surface of the substrate 62/heater assembly) and therefore can experience some degree of heating.

In addition, the direction in which the distribution channels 622 to 622c extend is not particularly limited. With reference to FIG. 3a, the distribution channels 622 to 622c are not limited to being provided in the region of the heater assembly facing the air channel 73. Indeed, in some implementations, the distribution channels 622 to 622c may extend so as to overlap with the top surface 71 of the lower support unit 7. These distribution channels may help provide additional surface area of the electrically resistive layer 64 which would otherwise be unusable owing to the fact that aerosol may not escape from the surface of the electrically resistive layer 64 in such cases. Providing the distribution channels 622 to 622c may additionally provide the benefit of increasing the available surface area for vaporising liquid, although this may depend on the specific arrangement of the heater assembly 6 within the cartomiser 3.

Thus, broadly speaking, in accordance with the present disclosure, the heater assembly 6 includes one or more distribution channels 621-621c, 622-622c which are provided on a surface of the substrate 62 of the heater assembly 6 and extend along a predetermined path on the surface of the substrate 62. When the one or more distribution channels are provided on a surface of the substrate 62 that faces the reservoir 46, the distribution channels 621-621c are provided for supplying liquid aerosol-generating material to the capillary tubes 66 or to a porous portion of the substrate 62. When the one or more distribution channels are provided on a surface of the substrate 62 that faces the electrically resistive layer 64, the distribution channels 622-622c are provided for distributing aerosol-generating material across the electrically resistive layer 64 and/or for collecting condensed liquid. These distribution channels 622-622c may optionally be configured to allow condensed liquid to return to the capillary tubes 66.

In some of the examples described above, the distribution channels 621-621c extend to the side surfaces 6c or 6d of the heater assembly 6. Predominantly, this arrangement of the distribution channels 621-621c offers the benefit of providing openings of the distribution channels 621-621c that are provided on surfaces of the substrate 62/heater assembly 6 that are exposed to the reservoir 46 and therefore in fluid contact with the liquid in the reservoir 46. This increases the possible routes for liquid to travel to the capillary tubes 66. However, it may not be necessary in each implementation to provide the distribution channels 621-621c that are in direct contact with the reservoir 46 extending to the side surfaces 6c or 6d of the heater assembly 6. Equally, in some of the examples described above, the distribution channels 622-622c do not extend to the side surfaces 6c or 6d of the heater assembly 6. Predominantly, this arrangement of the distribution channels 622-622c may be more suited for the heater layer 64 where it is desired to not directly contact the liquid in the liquid reservoir 46 (without first going via the capillary tubes 66). However, this may not always be the case, and if extending the distribution channels 622-622c to the surfaces 6c, 6d does not bring the distribution channels 622-622c into contact with the reservoir 46, then it may be possible to extend the distribution channels to the side surface of the heater assembly (e.g., in the central portion 67 of the heater assembly that is provided in the air channel 73). Additionally, in some implementations, a side surface of the heater assembly may be defined by a surface that shares an edge with the shares an edge with the first outer surface (e.g., surface 6a) of the heater assembly 6.

The specific arrangement of the distribution channels 621-621c, 622-622c may depend on the application at hand and the desired effect. For example, the distribution channels 621-621c may be arranged to deliver aerosol-generating material to a particular region or regions of the heater assembly (e.g., a central region of the heater assembly, e.g., central portion 67). The distribution channels 622-622c may be arranged to distribute aerosol-generating material to a particular region or regions of the heater assembly (e.g., into or away from a central region of the heater assembly, e.g., central portion 67). However, each distribution channel 621-621c, 622-622c is provided to extend along a predetermined path in a direction that is parallel with the surface of the substrate 62.

It has been described above that the distribution channels 621-621c, 622-622c are formed on a surface of the substrate 62, for example through machining, drilling, etching etc. However, it should be appreciated that distribution channels 621-621c, 622-622c may be formed using other techniques such as, scratching the surface of the heater assembly 6 with sandpaper, diamond wheel, diamond file, etc. Distribution channels formed in this way could have a more irregular distribution on the surface of the heater assembly 6. Nonetheless, once formed on the surface of the substrate, the distribution channels formed in this way cause liquid aerosol-generating material to follow a path that is constrained to the surface of the substrate 62, although owing to the way in which the distribution channels are formed it may be that certain paths may overlap essentially providing multiple routes for liquid to travel along.

So far it has been described that the distribution channels 621-621c, 622-622c are provided on a surface of the substrate 62 which broadly corresponds to at least one outer surface of the heater assembly 6. However, the present disclosure is not limited to such configurations.

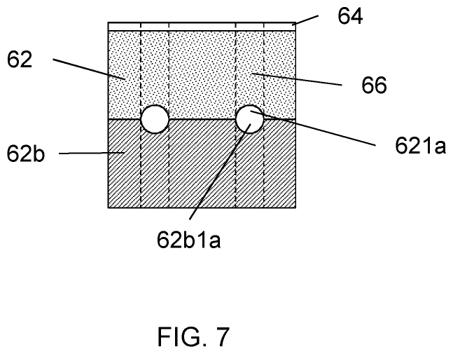

FIG. 7 is a schematic representation of a further implementation in which a plurality of substrates 62, 62b are provided forming the heater assembly 6. FIG. 7 is shown viewed along the longitudinal axis L2 of the heater assembly 6. Specifically, the side surface 6c of the heater assembly 6 is shown.

FIG. 7 shows a first substrate 62, which for the purposes of simplifying the explanation of the foregoing disclosure will be considered to be the substrate 62 of FIG. 5a. The substrate 62 includes the distribution channels 621a. The distribution channels 621a are provided on the lower surface of the substrate 62 (i.e., the surface of the substrate 62 that does not comprise the electrically resistive layer 64). However, as seen in FIG. 7, this surface is no longer the outer surface of the heater assembly 6. Instead, a second substrate 62b is provided. The first substrate 62 and the second substrate 62b are provided in a stacked arrangement. That is, the first substrate 62 is stacked on top of the second substrate 62b. The second substrate 62b may be largely identical to the first substrate 62, in terms of size, shape and material (although the substrates 62 may be different in other implementations). The second substrate 62b further includes a distribution channel 62b1a provided on a surface of the second substrate 62b. The first and second substrates 62, 62b are arranged such that the surfaces of the substrates 62, 62b comprising the distribution channels 621a, 62b1a abut one another. The two abutting surfaces may be joined using any suitable joining technique.

More generally, when a plurality of substrates 62, 62b are provided to form the heater assembly 6, one or more distribution channels are provided on one or more surfaces of the plurality of substrates that abut one another. In the described implementation, distribution channels 621a, 62b1a are provided on surfaces of both the first and second substrates 62, 62b. In some implementations, only the distribution channels 621a are present on the surface of the substrate 62, while no distribution channels are provided on the surface of the substrate 62b. Conversely, in other implementations, only the distribution channels 62b1a are present on the on the surface of the substrate 62b, while no distribution channels are provided on the surface of the substrate 62.

FIG. 7 shows the capillary tubes 66 in phantom extending through the heater assembly 6, and in particular through substrates 62 and 62b. As can be seen in FIG. 7, the distribution channels 621a and 62b1a intersect the capillary tubes 66. That is to say, the distribution channels 621a and 62b1a provide a predetermined path from the side surface 6c of the heater assembly to the capillary tubes 66. The pathway runs along the surfaces of the substrates 62, 62b but when the two substrates 62, 62b are assembled in the stacked arrangement, the distribution channels 621a and 62b1a provide a predetermined path that extends through an interior of the heater assembly 6. Similarly to the situation described with FIG. 5a, the openings of distribution channels 621a and 62b1a are provided at the end surface 6c of the heater assembly 6 and similarly are positioned in the well 53 of the cartomiser 3. Accordingly, liquid is capable of entering the distribution channels 621a and 62b1a and passing to the capillary tubes 66. However, in some implementations, for example when the substrate 62 is porous, the distribution channels 621a and 62b1a need not extend to the end surface 6c of the heater assembly 6. In such implementations, liquid aerosol-generating material is permitted to enter the distribution channels 621a and 62b1a via the random path provided by the interconnected pores.

In examples where a first distribution channel 621a is provided on a surface of a first substrate 62 of the plurality of substrates, and a second distribution channel 62b1a is provided on a surface of a second substrate 62 of the plurality of substrates, the first distribution channel 621a and the second distribution channel 62b1a follow the same predetermined path such that, when the first substrate 62 and the second substrate 62b are stacked on each other, the first distribution channel 621a and the second distribution channel 62b1a face each other. The distribution channels 621a and 62b1a in this instance combined with one another to form a combined distribution channel. That is to say, distribution channel 621a is a groove having a semi-circular cross sectional shape, and distribution channel 62b1a is a groove having a semi-circular cross sectional shape, such that when combined, the combined distribution channel is a groove or tube having a circular cross-sectional shape that extends along the predetermined path.

Providing distribution channels on the surfaces of substrates 62, 62b forming the heater assembly that do not form an exposed surface of the heater assembly 6 can help to enable more efficient or customised wicking of the liquid. For example, providing channels through a centre of a solid substrate, e.g., through laser drilling or the like, may be relatively straightforward for simple paths (e.g., a linear path), but is difficult for more complex paths and/or to achieve more accurate alignment with the capillary tubes 66. Instead, providing complex patterns etched or machined onto the surface of the substrates that are subsequently arranged to be internal to the heater assembly can allow for much more complex patterns of distribution channels to be formed. This may more readily allow targeted delivery of liquid to select capillary tubes 66 (for example, provided in certain regions of the heater assembly). Hence, broadly, providing distribution channels on the surfaces of stacked substrates, where those surfaces are not the external surfaces of the heater assembly 6, can further help aid the delivery of aerosol-generating material to ones of the capillary tubes 66.

It should also be understood that while FIG. 7 only shows the distribution channels provided on the surfaces of the substrate 62, 62b that are provided internal to the heater assembly 6 when the substrates are stacked, it should also be understood that distribution channels may be provided on the outer surfaces of the heater assembly 6 substantially as described above (that is, on the surface of the substrate 62b corresponding to the second surface 6b of the heater assembly and/or on the surface of the substrate 62 onto which the electrically resistive layer 64 is disposed and which is parallel to the first surface 6a of the heater assembly).

The heater assembly 6 as described above is generally provided as a relatively small component having a relatively small footprint (as compared to more traditional heater assemblies, such as a wick and coil). However, owing in part to the fact the capillary tubes 66 are formed via a manufacturing process in the heater assembly 6 (i.e., the capillary tubes are engineered, e.g., through a laser drilling process), and the distribution channels are provided to the heater assembly 6, the heater assembly 6 can provide similar if not improved liquid delivery characteristics and/or aerosol formation characteristics despite its relatively small size. By providing a smaller component, material wastage (e.g., when the cartomiser 3 is disposed of) can be reduced.

It should be appreciated that the configuration of the cartomiser 3 accommodating the heater assembly 6 is provided as an example configuration of such a cartomiser 3. The principles of the present disclosure apply equally to other configurations of the cartomiser 3 (for example, comprising similar or different components to those as shown in FIGS. 1 and 2, and a similar or different layout to that shown in FIG. 2). That is, the cartomiser 3 and the relative position of the heater assembly 6 in the cartomiser 3 is not significant to the principles of the present disclosure. Broadly speaking, a cartomiser is likely to comprise a top end (having the mouthpiece orifice 41) and a bottom end. In the examples shown above, the heater assembly 6 is arranged to be below the reservoir 46, substantially horizontal to the longitudinal axis of the cartomiser 3, and arranged in an airflow path that is substantially perpendicular to longitudinal axis of the heater assembly. However, this need not be case, and in other implementations the cartomiser 3 may be configured differently depending on the particular design and application at hand. For example, the heater assembly 6 may be arranged such that airflow is substantially parallel to the longitudinal axis of the heater assembly, e.g., along the exposed surface of the electrically resistive layer 64. For example, the upper sealing unit 5 may not be provided with the central air passage 58 and instead the air passage may be provided to one side of the upper sealing unit 5. Air may enter the cartomiser 3 by a suitable inlet and flow along the longitudinal surface of the heater assembly 6 (and along the electrically resistive layer 64) before passing in a substantially vertical direction through the air passage 58 positioned at one end of the upper sealing unit 5 (e.g., the end opposite the air inlet). The outer housing 4 and mouthpiece orifice 41 may be suitably configured. In such an example, the entirely of the second surface 6b of the heater assembly may be exposed to the reservoir 46. In such implementations, the capillary tubes 66 may be disposed across the heater assembly 6, not just within the central portion 67 of the heater assembly 6 (provided the electrically resistive layer 64 is capable of coupling to a power source). Hence, although the heater assembly 6 has been described in the specific context of the example cartomiser 3 of FIGS. 2 and 3a to 3b, the principles described herein can be applied to different heater assemblies for use in different cartomisers 3.

In the example shown in FIG. 2, the contact pads 75 directly contact the electrically resistive layer 64 of the heater assembly 6. However, the cartomiser 3 may be provided with any suitable arrangement that facilitates the electrical contact between the aerosol provision device 2 and the heater assembly 6. For example, in some implementations, electrical wiring or other electrically conductive elements may extend between the electrically resistive layer 64 and the contact pads 75 of the cartomiser 3. This may particularly be the case when the heater assembly 6 has its largest dimension (e.g., its length) less than a minimum distance between the contact pads 75. The distance between the contact pads 75 may be dictated by the electrical contacts on the aerosol provision device 2.

It should also be appreciated that while the above has described a cartomiser 3 which includes the heater assembly 6, in some implementations the heater assembly 6 may be provided in the aerosol provision device 2 itself. For example, the aerosol provision device 2 may comprise the heater assembly 6 and a removable cartridge (containing a reservoir of liquid aerosol-generating material). The heater assembly 6 is provided in fluid contact with the liquid in the cartridge (e.g., via a suitable wicking element or via another fluid transport mechanism). Alternatively, the aerosol provision device 2 may include an integrated liquid storage area in addition to the heater assembly 6 which may be refillable with liquid. More broadly, the aerosol provision system (which encompasses a separable aerosol provision device and cartomiser/cartridge or an integrated aerosol provision device and cartridge) includes the heater assembly.

Additionally, the above has described a heater assembly 6 in which an electrically resistive layer 64 is provided on a surface of the respective substrate. In the aerosol provision system 1 of FIG. 2, electrical power is supplied to the electrically resistive layer 64 via the contact pads 75. Accordingly, an electrical current is able to flow through the electrically resistive layer 64 from one end to the other to cause heating of the electrically resistive layer 64. However, it should be understood that electrical power for the purposes of causing the electrically resistive layer 64 to heat may be provided via an alternative means, and in particular, via induction. In such implementations, the aerosol provision system 1 is provided with a coil (known as a drive coil) to which an alternating electrical current is applied. This subsequently generates an alternating magnetic field. When the electrically resistive layer 64 is exposed to the alternating magnetic field (and it is of sufficient strength), the alternating magnetic field causes electrical current (Eddy currents) to be generated in the electrically resistive layer 64. These currents can cause Joule heating of the electrically resistive layer 64 owing to the electrical resistance of this layer 64. Depending on the material which the electrically resistive layer 64 is formed, heating may additionally be generated through magnetic hysteresis (if the material is ferro- or ferrimagnetic). More generally, the electrically resistive layer 64 is an example of a heater layer of the heater assembly 6 which is configured to generate heat when supplied with energy (e.g., electrical energy), which, for example, may be provided through direct contact or via induction. Additional ways of causing the heater layer to generate heat are also considered within the principles of the present disclosure.

Moreover, it should be understood that in some implementations, an additional layer or layers, e.g., serving as a protective layer, may be disposed on top of the electrically resistive layer 64. In such implementations, the capillary tubes 66 still extend to an opening on the electrically resistive layer 64 but may additionally extend through the additional layer(s). More broadly, the capillary tubes 66 extend through the heater assembly 6 to an opening at a surface of a side of the heater assembly 6 comprising the electrically resistive layer 64, which includes an opening in the electrically resistive layer 64 itself as well as an opening in any additional layer(s) positioned above the electrically resistive layer 64.

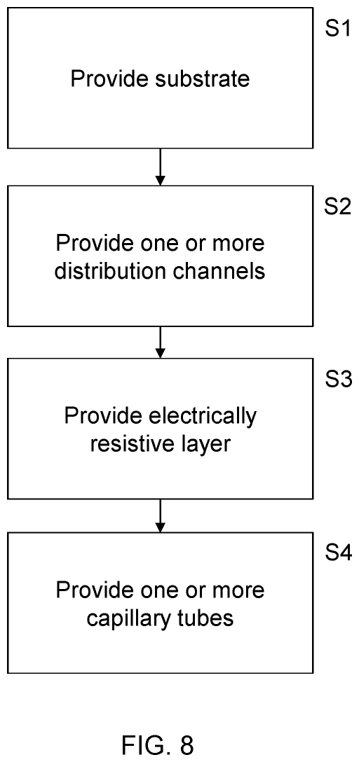

FIG. 8 depicts an example method for manufacturing a heater assembly 6.

The method begins at step S1 by providing a substrate 62. The way in which the substrate 62 is formed is not significant to the principles of the present disclosure. For example, the substrate 62 may be cut from a portion of cultured quartz or formed via a sintering process by sintering quartz powders/fibres, for example.

The method then proceeds to step S2 whereby the one or more distribution channels 621-621c, 622-622c are provided. More specifically, the one or more distribution channels 621-621c, 622-622c are formed on a surface of the substrate 62, for example using a suitable subtractive manufacturing technique. Alternatively, the one or more distribution channels 621-621c, 622-622c may be formed during the provision of the substrate 62 in step S1; for example, the substrate 62 may be sintered according to a predetermined shape which includes the one or more distribution channels 621-621c, 622-622c. As noted above, the one or more distribution channels 621-621c, 622-622c are formed on a surface of the substrate 62 which forms a surface (surface 6b) of the heater assembly 6 that is in fluid contact with the aerosol-generating material in the reservoir and/or are formed on a surface of the substrate 62 which is intended to have the electrically resistive layer 64 disposed thereon (a surface parallel to the surface 6a of the heater assembly 6). Alternatively or additionally, in some implementations, the one or more distribution channels 621-621c, 622-622c are provided on a surface of the substrate 62 that does not form an outer surface of the heater assembly 6 but is instead intended to abut against a surface of a second substrate (e.g., substrate 62b).

According to the described implementation, when the one or more distribution channels 621-621c, 622-622c have been formed on a surface of the substrate 62, the method proceeds to step S3, where the electrically resistive layer 64 is provided on a surface of the substrate 62. The way in which the electrically resistive layer 64 is formed on the surface of the substrate 62 is not significant to the principles of the present disclosure. For example, the electrically resistive layer 64 may be a sheet of metal (e.g., titanium) adhered, welded, or the like to the substrate 62. Alternatively, the electrically resistive layer 64 may be formed through a vapour or chemical deposition technique using the substrate 62 as a base. It should be appreciated that the electrically resistive layer 64 is not necessarily deposited on the surface of the substrate 62 that includes the one or more distribution channels 621-621c, 622-622c. In the event that the electrically resistive layer 64 is deposited on the surface of the substrate 62 that comprises the distribution channels 622-622c, then as described above in relation to FIG. 4, the electrically resistive layer 64 is deposited on the surfaces of the distribution channels 622-622c, thereby effectively lining the distribution channels 622-622c with the electrically resistive layer 64.

Alternatively, it should be appreciated that step S2 may be performed after the electrically resistive layer 64 is deposited on the substrate 62 at step S3. For distribution channels 622-622c provided on the surface of the substrate 62 that is intended to have the electrically resistive layer 64 disposed thereon, if the distribution channels 622-622c are formed after the electrically resistive layer 64 is disposed on the surface of the substrate 62, then the formation of the distribution channels 622-622c subsequently removes the electrically resistive layer 64 from the surface of the substrate 62 where the distribution channels 622-622c are formed.

It should also be appreciated that step S3 may also occur before step S1 (and step S2). For example, a further alternative is to grow or culture the substrate 62 using the electrically resistive layer 64 as a base. Subsequent processing steps, such as step S2, may be performed thereafter.

In the described example, after step S3, the method proceeds to step S4. At step S4, one or more capillary tubes 66 are formed in the substrate 62/electrically resistive layer 64. As noted above, the capillary tubes 66 extend from a surface (surface 6b) of the substrate 62/heater assembly 6, through the electrically resistive layer 64 provided on the first surface of the substrate 62. That is, the capillary tubes 66 extend all the way through the heater assembly 6. The capillary tubes 66 may be formed by laser drilling, as noted above, or any other suitable technique. The capillary tubes 66 may be formed in such a way as to align with the one or more distribution channels 621-621c, 622-622c formed in the substrate 62, such that the capillary tubes 66 are essentially in fluid communication with the one or more distribution channels 621-621c, 622-622c as described above. Alternatively, the capillary tubes 66 may be formed in regions where the one or more distribution channels 621-621c, 622-622c are not present on the surface of the substrate 62.

It should be appreciated that step S4 may be performed prior to steps S2 and S3 (and equally step S4 may follow step S1 where step S3 is performed prior to step S1). That is to say, the capillary tubes 66 may be formed in the substrate 62 prior to forming the distribution channels 621-621c, 622-622c and/or applying the electrically resistive layer 64.

Broadly, it should be understood that the method of FIG. 8 is an example method only, and adaptations to the steps or ordering of the steps of this method are contemplated within this disclosure, for example, as described above.

After step S4, the heater assembly 6 is formed, and subsequently may be assembled to form the cartomiser 3 (or more generally, the heater assembly 6 may be positioned in an aerosol provision system 1).

Although FIG. 8 shows the method ending at step S4, it should be understood that in the event that a plurality of substrates 62, 62b are to be used to form the heater assembly 6, the method may additionally include the steps of forming the second substrate 62b broadly as described above with steps S1 to S4, although step S3 is excluded and step S2 may optionally be excluded if distribution channels 621-621c, 622-622c are not to be provided on the second substrate 62b, and further including the step of joining the substrate 62 and the second substrate 62b (e.g., through a suitable bonding technique such as welding or adhesion), where the surface of the substrate 62 having the one or more distribution channels formed thereon 621-621c, 622-622c is abutted against a surface of the second substrate 62b (which may or may not include one or more distribution channels).

Thus, there has been described a heater assembly for an aerosol provision system, the heater assembly having a plurality of outer surfaces including a first outer surface. The heater assembly further includes: a substrate; a heater layer configured to generate heat when supplied with energy, the heater layer provided at the first outer surface of the heater assembly; one or more capillary tubes extending from another outer surface of the heater assembly through the heater layer provided at the first outer surface of the heater assembly; and one or more distribution channels provided on a surface of the substrate and for guiding aerosol-generating material along a path extending along the surface of the substrate. Also described is an aerosol provision system including the heater assembly and a method for manufacturing a heater assembly.

While the above described embodiments have in some respects focused on some specific example aerosol provision systems, it will be appreciated the same principles can be applied for aerosol provision systems using other technologies. That is to say, the specific manner in which various aspects of the aerosol provision system function are not directly relevant to the principles underlying the examples described herein.

In other implementations, there is provided a heater assembly for an aerosol provision system, the heater assembly including a substrate; a heater layer configured to generate heat when supplied with energy, the heater layer provided on a first surface of the substrate; one or more capillary tubes extending from another surface of the substrate through the heater layer provided on the first surface of the substrate, the one or more capillary tubes for supplying aerosol-generating material to the heater layer for vaporisation; and one or more distribution channels, optionally extending from at least one capillary tube. The one or more distribution channels follow a substantially linear (horizontal) path for supplying aerosol-generating material to or from the one or more capillary tubes. In such implementations, the one or more distribution tubes need not be provided on the surface of the substrate, but instead may be provided extending through a solid substrate. In other words, the distribution channels in such implementations, may be drilled or otherwise formed through the body of the substrate, optionally to intersect with the capillary tubes 66. In such instances, the distribution channels are formed so as to have an opening on a surface of the substrate which is intended to contact the liquid in the reservoir 46 but which is not the surface of the substrate that includes openings for the capillary tubes 66. In other words, with reference to FIG. 4, this may include the surfaces 6c and 6d, but not the surfaces 6a and 6b. Such distribution channels may offer some improvement in the wicking of liquid to the capillary tubes 66.

In order to address various issues and advance the art, this disclosure shows by way of illustration various embodiments in which the claimed invention(s) may be practiced. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. A heater assembly for an aerosol provision system, the heater assembly having a plurality of outer surfaces including a first outer surface, the heater assembly comprising:
a substrate;
a heater layer configured to generate heat when supplied with energy, the heater layer provided at the first outer surface of the heater assembly;
one or more capillary tubes extending from another outer surface of the heater assembly through the heater layer provided at the first outer surface of the heater assembly; and
one or more distribution channels provided on a surface of the substrate and for guiding aerosol-generating material along a path extending along the surface of the substrate.

2. The heater assembly of claim 1, wherein the one or more distribution channels extend from at least one capillary tube, the one or more distribution channels for supplying aerosol-generating material to or from the one or more capillary tubes.

3. The heater assembly of claim 1, wherein at least one of the one or more distribution channels extend from a side surface of the heater assembly, each side surface of the heater assembly being a surface of the heater assembly other than the first outer surface or a surface opposite the first outer surface.

4. The heater assembly of claim 1, wherein at least one of the one or more distribution channels extend from a side surface of the heater assembly, each side surface of the heater assembly being a surface of the heater assembly that shares an edge with the first outer surface of the heater assembly.

5. The heater assembly of claim 1, wherein the one or more distribution channels comprise a groove provided on the surface of the substrate.

6. The heater assembly of claim 5, wherein the groove has a semi-circle cross-sectional area when viewed along the direction of extent of the distribution channel.

7. The heater assembly of claim 1, wherein the one or more distribution channels follow one of: a substantially linear path or a linear path; or a substantially zig-zag path or a zig-zag path.

8. The heater assembly of claim 1, wherein the one or more distribution channels extend along a direction substantially perpendicular or perpendicular to the direction of extent of the one or more capillary tubes.

9. The heater assembly of claim 1, wherein the substrate comprises a porous material having a plurality of pores, wherein at least some of the plurality of pores are interconnected and provide at least one random path along which aerosol-generating material may flow, wherein the path along which the one or more distribution channels extend is different to the random path provided by the interconnected pores.

10. The heater assembly of claim 1, wherein the heater assembly comprises a plurality of substrates, the plurality of substrates provided in a stacked arrangement, and wherein at least one of the one or more distribution channels are provided on one or more surfaces of the plurality of substrates that abut one another.

11. The heater assembly of claim 10, wherein a first distribution channel is provided on a surface of a first substrate of the plurality of substrates, and a second distribution channel is provided on a surface of a second substrate of the plurality of substrates, and wherein the first distribution channel and the second distribution channel follow the same pathway such that, when the first substrate and the second substrate are stacked on each other, the first distribution channel and the second distribution channel face each other.

12. The heater assembly of claim 1, wherein at least one of the one or more distribution channels are provided on the first outer surface of the heater assembly, and wherein the heater layer is at least partly disposed in the at least one distribution channel.

13. An aerosol provision system comprising the heater assembly of claim 1, wherein the aerosol provision system comprises an aerosol-generating material storage portion for storing aerosol-generating material.

14. An aerosol provision system according to claim 13, wherein at least one of the one or more distribution channels extend from a side surface of the heater assembly, each side surface of the heater assembly begin a surface of the heater assembly other than the first outer surface or a surface opposite the first outer surface, wherein the heater assembly is arranged such that aerosol-generating material held in the aerosol-generating material storage portion is capable of being delivered to one or more side surfaces of the heater assembly.

15. A method for manufacturing a heater assembly for an aerosol provision system, the heater assembly having a plurality of outer surfaces including a first outer surface, the method comprising:
providing a substrate;
providing a heater layer at the first outer surface of the heater assembly, the heater layer configured to generate heat when supplied with energy;
providing one or more capillary tubes extending from another outer surface of the heater assembly through the heater layer provided at the first outer surface of the heater assembly; and
providing one or more distribution channels provided on a surface of the substrate and for guiding aerosol-generating material along a path extending along the surface of the substrate.

16. The method of claim 15, wherein the one or more distribution channels are formed by removing material from the surface of the substrate.

17. The method of claim 15, wherein the method further includes providing a second substrate, wherein one or more distribution channels are formed on a surface of the substrate, wherein the method further comprises:
abutting the substrate and the second substrate together, wherein the surface of the substrate having the one or more distribution channels formed thereon is abutted against a surface of the second substrate.

18. A heater means for an aerosol provision system, the heater means having a plurality of outer surfaces including a first outer surface, the heater means comprising:
a substrate;
heater layer means configured to generate heat when supplied with energy, the heater layer means provided at the first outer surface of the heater means;
capillary means extending from another outer surface of the heater means through the heater layer means provided at the first outer surface of the heater means; and
distribution means provided on a surface of the substrate and for guiding aerosol-generating material along a path along the surface of the substrate.

19. An aerosol provision system according to claim 13, wherein at least one of the one or more distribution channels extend from a side surface of the heater assembly, each side surface of the heater assembly being a surface of the heater assembly that shares an edge with the first outer surface of the heater assembly, wherein the heater assembly is arranged such that aerosol-generating material held in the aerosol-generating material storage portion is capable of being delivered to one or more side surfaces of the heater assembly.
